(19) United States
(12) Patent Application Publication
(10) Pub. No.: US 2017/0257751 A1
(43) Pub. Date: Sep. 7, 2017

(54) Off-Network Wireless Mission Critical Session Initiation

(71) Applicant: Ofinno Technologies, LLC, Herndon, VA (US)

(72) Inventors: Roozbeh Atarius, Herndon, VA (US); Esmael Hejazi Dinan, Herndon, VA (US)

(73) Assignee: Ofinno Technologies, LLC, Herndon, VA (US)

(21) Appl. No.: 15/450,849

(22) Filed: Mar. 6, 2017

Related U.S. Application Data
(60) Provisional application No. 62/304,155, filed on Mar. 5, 2016.
(60) Provisional application No. 62/304,156, filed on Mar. 5, 2016.

(51) Int. Cl. H04W 8/00; H04W 4/00; H04W 12/02

(52) U.S. Cl. CPC H04W 8/005; H04W 12/02; H04W 4/005

(57) ABSTRACT

A first off-network wireless device discovers a second off-network wireless device employing a proximity services (ProSe) discovery procedure. The first off-network wireless device receives a broadcast announcement for an off-network session identifying one or more first required capabilities from the second off-network wireless device. The first off-network wireless device determines when the first off-network wireless device is compliant with the one or more first required capabilities. The first off-network wireless device joins the off-network session in response to the first off-network wireless device being compliant.

### CROSS-REFERENCE TO RELATED APPLICATIONS

This application claims the benefit of U.S. Provisional Application No. 62/304,156, filed Mar. 5, 2016, and U.S. Provisional Application No. 62/304,155, filed Mar. 5, 2016, which are hereby incorporated by reference in its entirety.

### BRIEF DESCRIPTION OF THE SEVERAL VIEWS OF THE DRAWINGS

Examples of several of the various embodiments of the present invention are described herein with reference to the drawings.

FIG. 1 illustrates a block diagram of an example system 100 according to various embodiments.

FIG. 2 is a system diagram of an example communications system in which one or more disclosed embodiments may be implemented.

FIG. 3 is a system diagram of an example wireless transmit/receive unit (WTRU) as per an aspect of an embodiment of the present disclosure.

FIG. 4 is a system diagram of an example radio access network and core network as per an aspect of an embodiment of the present disclosure.

FIG. 5 is a block diagram of a base station and a wireless device as per an aspect of an embodiment of the present disclosure.

FIG. 7 is a flow diagram of an example procedure for Model A discovery as per an aspect of an embodiment of the present disclosure.

FIG. 8 is a flow diagram showing an example procedures for the announcing MCS UE as per an aspect of an embodiment of the present disclosure.

FIG. 9 is a flow diagram showing an example procedures for the monitoring MCS UE as per an aspect of an embodiment of the present disclosure.

FIG. 10 is a flow diagram showing an example match reporting procedure as per an aspect of an embodiment of the present disclosure.

FIG. 11 is a flow diagram showing an example procedures for Model B discovery as per an aspect of an embodiment of the present disclosure.

FIG. 12 is a flow diagram showing an example procedure for the discoveree MCS UE as per an aspect of an embodiment of the present disclosure.

FIG. 13 is a flow diagram of an example procedure for discoverer MCS UE as per an aspect of an embodiment of the present disclosure.

FIG. 14 is a flow diagram showing an example matched reporting procedure as per an aspect of an embodiment of the present disclosure.

FIG. 15 is a diagram of a visibility configuration of multiple off-network wireless devices as per an aspect of an embodiment of the present disclosure.

FIG. 16 is an illustration of a visibility matrix as per an aspect of an embodiment of the present disclosure.

FIG. 17 is a diagram of a visibility configuration of multiple off-network wireless devices as per an aspect of an embodiment of the present disclosure.

FIG. 18 is an illustration of a visibility matrix as per an aspect of an embodiment of the present disclosure.

FIG. 19 is a flow diagram of an example media redistribution with respect to a visibility configuration as per an aspect of an embodiment of the present disclosure.

FIG. 20 is a diagram of a visibility matrix illustrating media distribution and redistribution as per an aspect of an embodiment of the present disclosure.

FIG. 21 is an example flow diagram of an announcement of a neighbor list as per an aspect of an embodiment of the present disclosure.

FIG. 22 is a flow diagram of a reception of a neighbor list as per an aspect of an embodiment of the present disclosure.

FIG. 23 is a diagram of an example visibility configuration of multiple off-network wireless devices as per an aspect of an embodiment of the present disclosure.

FIG. 24 is an illustration of an example visibility matrix as per an aspect of an embodiment of the present disclosure.

FIG. 25 is a flow diagram of an example media redistribution with respect to a visibility configuration as per an aspect of an embodiment of the present disclosure.

FIG. 26 is a diagram of an example visibility matrix illustrating media distribution and redistribution as per an aspect of an embodiment of the present disclosure.

FIG. 27 is a diagram illustrating segmentation of a neighbor list as per an aspect of an embodiment of the present disclosure.

FIG. 28 is a diagram illustrating reverse segmentation of a neighbor list as per an aspect of an embodiment of the present disclosure.

FIG. 29 is a diagram illustrating an example information element of a user diagram protocol as per an aspect of an embodiment of the present disclosure.

FIG. 30 is a diagram illustrating an example information element as per an aspect of an embodiment of the present disclosure.

FIG. 31 is a diagram illustrating an example packet format as per an aspect of an embodiment of the present disclosure.

FIG. 32A is a diagram illustrating an example information element as per an aspect of an embodiment of the present disclosure.

FIG. 32B is a diagram illustrating an example information element as per an aspect of an embodiment of the present disclosure.

FIG. 33 is a diagram illustrating an example information element as per an aspect of an embodiment of the present disclosure.

FIG. 34 is a diagram illustrating segmentation of a neighbor list as per an aspect of an embodiment of the present disclosure.

FIG. 35 is a diagram illustrating reverse segmentation of a neighbor list as per an aspect of an embodiment of the present disclosure.

FIG. 36 is a diagram illustrating an example information element as per an aspect of an embodiment of the present disclosure.

FIG. 37 is a diagram illustrating an example session announcement protocol as per an aspect of an embodiment of the present disclosure.

FIG. 38 is a diagram illustrating an example session announcement protocol packet header as per an aspect of an embodiment of the present disclosure.

FIG. 39 is a flow diagram of an off-network session setup as per an aspect of an embodiment of the present disclosure.

FIG. 40 is a flow diagram of an off-network session setup as per an aspect of an embodiment of the present disclosure.

FIG. 41 is an example flow diagram as per an aspect of an embodiment of the present disclosure.

FIG. 42 is an example flow diagram as per an aspect of an embodiment of the present disclosure.

### DETAILED DESCRIPTION OF EMBODIMENTS

Example embodiments are generally directed to critical communication service (e.g., A) that may involve use of wireless mobile telecommunication cellular and/or wireless mobile broadband technologies. Wireless mobile broadband technologies may include wireless technologies suitable for use with wireless devices and/or user equipment (UE), such as one or more third generation (3G), fourth generation (4G) or emerging fifth generation (5G) wireless standards, revisions, progeny and variants. Examples of wireless mobile broadband technologies may include without limitation any of the Institute of Electrical and Electronics Engineers (IEEE) 802.16m and 802.16p standards, 3rd Generation Partnership Project (3GPP) Long Term Evolution (LTE) and LTE-Advanced (LTE-A) standards, and International Mobile Telecommunications Advanced (IMT-ADV) standards, including their revisions, progeny, and variants. Other suitable examples may include, without limitation, Global System for Mobile Communications (GSM)/Enhanced Data Rates for GSM Evolution (EDGE) technologies, Universal Mobile Telecommunications System (UMTS)/High Speed Packet Access (HSPA) technologies, Worldwide Interoperability for Microwave Access (WiMAX) or the WiMAX II technologies, Code Division Multiple Access (CDMA) 2000 system technologies (e.g., CDMA2000 I×RTT, CDMA2000 EV-DO, CDMA EV-DV, and so forth), High Performance Radio Metropolitan Area Network (HIPERMAN) technologies as defined by the European Telecommunications Standards Institute (ETSI) Broadband Radio Access Networks (BRAN), Wireless Broadband (WiBro) technologies, GSM with General Packet Radio Service (GPRS) system (GSM/GPRS) technologies, High Speed Downlink Packet Access (HSDPA) technologies, High Speed Orthogonal Frequency-Division Multiplexing (OFDM) Packet Access (HSOPA) technologies, High-Speed Uplink Packet Access (HSUPA) system technologies, 3 GPP Rel. 8, 9, 10 or 11 of LTE/System Architecture Evolution (SAE), and so forth. The examples are not limited in this context. In this disclosure, the term “critical” is being employed as a term of art as disclosed, for example, in various communication specifications and is therefore not intended to otherwise limit the scope of the claims.

By way of example and not limitation, various examples may be described with specific reference to various 3 GPP radio access network (RAN) standards, such as the 3 GPP Universal Terrestrial Radio Access Network (UTRAN), the 3 GPP Evolved Universal Terrestrial Radio Access Network (E-UTRAN) and 3GPP's suite of UMTS and LTE/LTE-Advanced Technical Specifications (in case of LTE/LTE-Advanced collectively “3GPP LTE Specifications” according to the 36 Series of Technical Specifications), and IEEE 802.16 standards, such as, for example, the IEEE 802.16-2009 standard and current third revision to IEEE 802.16 referred to as “802.16 Rev3” consolidating standards 802.16-2009, 802.16h-2010 and 802.16m-2011, and the IEEE 802.16p draft standards including IEEE P802.16.1b/D2 Jan. 2012 titled “Draft Amendment to IEEE Standard for WirelessMAN-Advanced Air Interface for Broadband Wireless Access Systems, Enhancements to Support Machine-to-Machine Applications” (collectively “IEEE 802.16 Standards”), and any drafts, revisions or variants of the 3 GPP LTE Specifications and the IEEE 802.16 Standards. Although some embodiments may be described as a 3GPP LTE Specifications or IEEE 802.16 Standards system by way of example and not limitation, it may be appreciated that other types of communications system may be implemented as various other types of mobile broadband communications systems and standards. The examples are not limited in this context.

As contemplated in the present disclosure, mission critical service (MCS) may support an enhanced mission critical push-to-talk (MCPTT) service, an enhanced mission critical video (MCVIDEO) service, an enhanced mission critical data/message (MCDATA) service, and/or the like. An MCS service may be suitable for mission critical scenarios and may be based upon 3GPP EPS services. MCS may typically be a session initiation protocol (SIP) based service that may be provided via a centralized MCS server residing in a network (e.g., a 3GPP EPS network). The MCS server may be an IP Multimedia Subsystem (IMS) application server, but the MCS server may also be a non-IMS based SIP server. User equipment (UEs) may directly attach to the network to receive critical communication services from an MCS server. Some UEs may also utilize Proximity Services (ProSe) capabilities to indirectly attach to the network through a relay UE. UEs utilizing ProSe capabilities may be outside of a coverage area of the network and may be referred to as remote UEs.

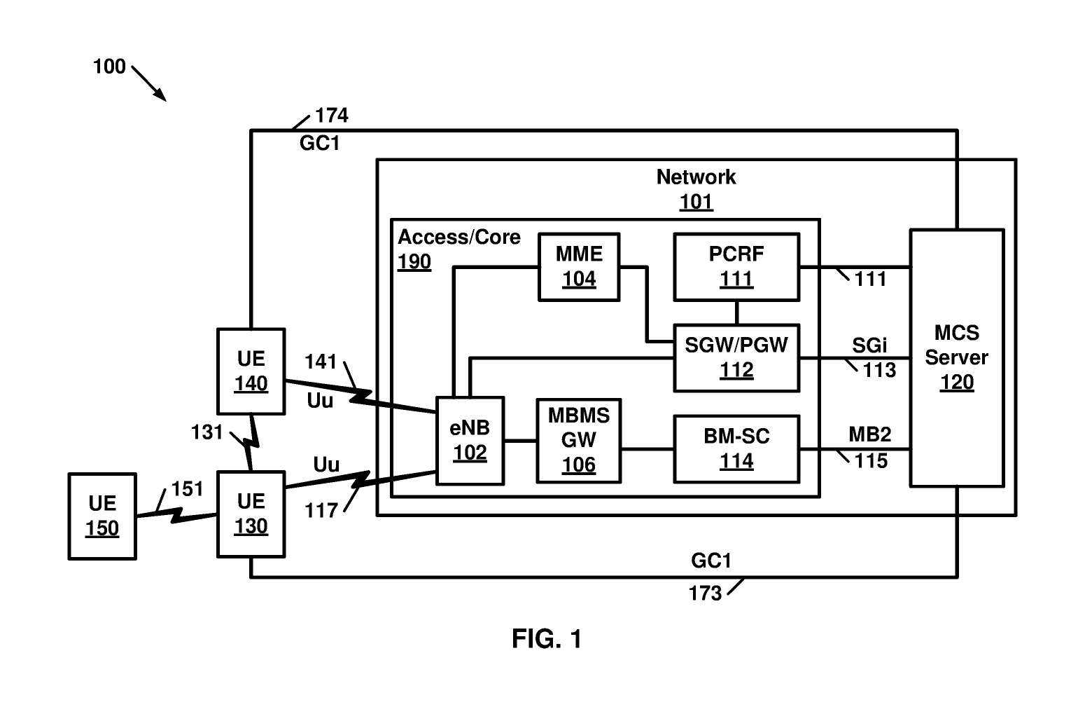

FIG. 1 illustrates a block diagram of an example system 100 according to various embodiments. According to an embodiment, elements of system 100 may be arranged for providing critical communication services to one or more UEs (e.g. UE 130, UE 140 and UE 150). These critical communication services may comprise MCS services as specified in, for example, 3GPP technical specification (TS) 22.179, entitled “Technical Specification Group Services and System Aspects; MCS over LTE, Stage 1”, Release 13, V13.0.1, published in January of 2015, and/or previous or subsequent releases or versions (hereinafter referred to as 3GPP TS 22.179). For example, as shown in FIG. 1, a network 101 may include an MCS server 120 that may serve as centralized server to enable network 101 to provide a SIP-based critical communication service to UEs 130, 140 or 150. MCS server 120 may be arranged as, for example, an IMS application server or a non-IMS based SIP server.

According to an embodiment, access/core 190 may comprise elements of network 101 typically associated with 3GPP E-UTRAN access and 3GPP E-UTRAN core elements. For example, a UE such as UE 130 may gain access to network 101 via Uu 117 coupled to evolved Node B (eNB) 102. Also, as shown in FIG. 1, MCS server 120 may couple to various access/core 190 elements. For example, MCS server 120 may couple to a policy and charging rules function (PCRF) 111 via 111. Link 111 may represent an Rx interface reference point. MCS server 120 may also couple to a serving gateway/packet data gateway (SGW/PWG) 112 via SGi 113. SGi 113 may represent an SGi interface reference point. (According to various embodiments, an interface may comprise and/or be a reference point). MCS server 120 may also couple to a broadcast/multicast-service center (BM-SC) 114 via MB2 115. MB2 115 may represent an MB2 reference point.

Mobile management entity (MME) 104 and multimedia broadcast/multicast service gateway (MBMS GW) 106 may provide core 3 GPP E-UTRAN services to MCS server 120 and/or UEs 130, 140 and 150 to facilitate network 101 in providing critical communication services.

According to an embodiment, UE 130 may attach directly to MCS server 120. UE 130 may comprise an MCS client that may be arranged as a SIP-based MCS client for communication with MCS server 120. MCS server 120 may be arranged as a type of group communication service application server (GCS AS) and GC1 173 may represent a GC1 reference point through which MCS server 120 couples with MCS client at UE 130.

According to an embodiment, UEs out of network coverage of network 101 may still be able to obtain critical communication service by coupling through UEs serving as UE-to-network relays such as UE 130. For example, UE 150 may be able to indirectly couple to MCS server 120 via a first link 151 between UE 150 and UE 130 and through a second link (GC1 173) between UE 130 and MCS server 120.

According to an embodiment, UE 130 acting as an UE-to-network relay may relay traffic from MCS server 120 for authorized UEs and/or authorized groups of UEs (e.g., belonging to an MCS group). UE 130 may act as an UE-to-network relay for groups of which it is not a member. As such, a relay UE, such as UE 130, may comprise logic and/or features to enable the relay UE to act as a node between an MCS server and a remote UE such as UE 150 via link 151.

According to an embodiment, critical communication content may be delivered to directly coupled UEs such as UEs 130 or 140 in either a unicast mode (e.g., via EPS bearers) and/or in multicast mode (e.g., via evolved MBMS (eMBMS) bearers). Use of eMBMS bearers may be justified in cases where a sufficient number of UEs are physically located within a same coverage area or cell. When the number of UEs in a cell is low, unicast delivery via EPS may be more efficient compared to eMBMS or multicast delivery. MCS server 120 may comprise logic and/or features capable of monitoring the number of UEs in a cell and then adjust a delivery mode accordingly.

According to an embodiment, as part of ProSe capabilities, UE 130 and UE 150 may establish a direct link 151. UE 130 may couple to MCS server 120 through GC1 173. Alternatively, UE 150 may couple to MCS server 120 via: (1) link 151 between UE 150 and UE 130; (2) link 131 between UE 130 and UE 140; and (3) GCI 174 between UE 140 to MCS Server 120. Establishment of the direct link may comprise relay discovery, mutual authentication and IP address assignment. Establishment of the direct link may comprise UE 130 and UE 150 setting up a wireless local area network (WLAN) direct connection. The WLAN direct connection may be arranged to operate according to Ethernet wireless standards (including progenies and variants) associated with the IEEE Standard for Information technology-Telecommunications and information exchange between systems—Local and metropolitan area networks—Specific requirements Part 11: WLAN Media Access Controller (MAC) and Physical Layer (PHY) Specifications, published March 2012, and/or later versions of this standard (“IEEE 802.11”). According to an embodiment, following the same logic as mentioned above for MCS server 120 selecting a unicast or multicast delivery mode, logic and/or features of a relay UE such as UE 130 and/or 140 may choose a unicast or multicast delivery mode to relay information (e.g., critical communication content) to one or more remote UEs such as UE 150 and/or each other.

A direct link between UEs 140 and 130 may be established via, for example, a PC5 interface (e.g. 131). The PC5 interface may be selectively chosen to communicate information. It may be possible to use unicast delivery via the LTE-Uu interface.

Concepts expressed herein may be implemented in connection with cellular telephones and/or other types of User Equipment (UE) used on communication networks, and particularly wireless communication networks. Described below are one or more example communication networks and related equipment within which at least some of the aspects of the herein described concepts may be implemented.

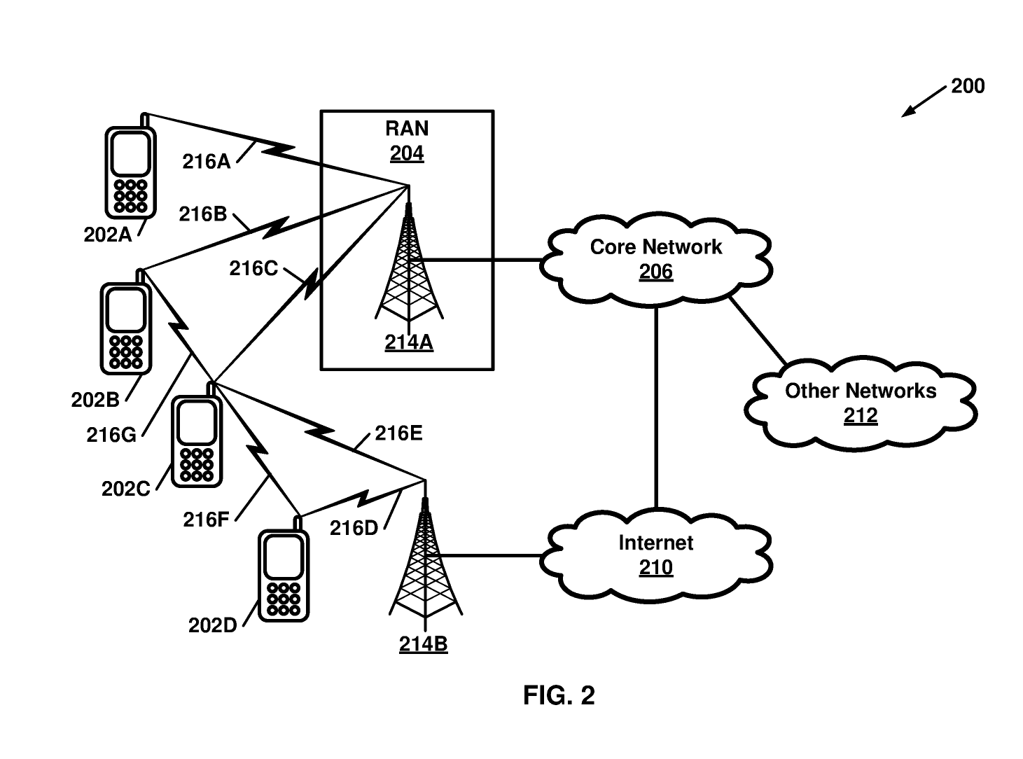

FIG. 2 is a diagram of an example communications system 200 in which one or more disclosed embodiments may be implemented. The communications system 200 may comprise a multiple access system configured to provide content, such as voice, data, video, messaging, broadcast, etc., to multiple wireless users. The communications system 200 may enable multiple wireless users to access such content through the sharing of system resources, including, for example, wireless bandwidth. For example, communications systems 200 may employ one or more channel access processes, such as code division multiple access (CDMA), time division multiple access (TDMA), frequency division multiple access (FDMA), orthogonal FDMA (OFDMA), single-carrier FDMA (SC-FDMA), and/or the like.

As shown in FIG. 2, the communications system 200 may comprise wireless transmit/receive units (WTRUs) 202A, 202B, 202C, 202D, a radio access network (RAN) 204, a core network 206, the Internet 210, and/or other networks 212. It will be appreciated that the disclosed embodiments contemplate various numbers of WTRUs, base stations, networks, and/or network elements. Each of the WTRUs 202A, 202B, 202C, 202D may be configured to operate and/or communicate in a wireless environment. By way of example, WTRUs 202A, 202B, 202C, 202D may be configured to transmit and/or receive wireless signals and may comprise user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, combinations thereof, and/or the like.

The communications systems 200 may also comprise a base station 214A and/or base station 214B. Each of the base stations 214A, 214B may be a type of device configured to wirelessly interface with at least one of the WTRUs 202A, 202B, 202C, 202D to facilitate access to one or more communication networks, such as core network 206, Internet 210 and/or networks 212. By way of example, base stations 214A and/or 214B may comprise a base transceiver station (BTS), a Node-B, an eNode B, a Home Node B, a Home eNode B, a site controller, an access point (AP), a wireless router, combinations thereof, and/or the like. While base stations 214A and 214B are each depicted as a single element, it will be appreciated that base stations 214A and 214B may comprise various numbers of interconnected base stations and/or network elements.

As illustrated, base station 214A may be a part of the RAN 204, which may also comprise other base stations and/or network elements (not shown), such as, for example, a base station controller (BSC), a radio network controller (RNC), relay nodes, combinations thereof, and/or the like. Base station 214A and/or the base station 214B may be configured to transmit and/or receive wireless signals within a particular geographic region, which may be referred to as a cell (not shown). The cell may be further divided into cell sectors. For example, the cell associated with the base station 214A may be divided into three sectors. Thus, according to an embodiment, base station 214A may comprise three transceivers, i.e., one for each sector of the cell. According to an embodiment, base station 214A may employ multiple-input multiple output (MIMO) technology and, therefore, may utilize multiple transceivers for each sector of the cell.

Base stations 214A and/or 214B may communicate with one or more of the WTRUs (e.g. 202A, 202B, 202C, and 202D) over an air interface (e.g. 216A, 216B, (216C and/or 216E), and 216D, respectively), which may comprise a wireless communication link (e.g., radio frequency (RF), microwave, infrared (IR), ultraviolet (UV), visible light, etc.). An air interface (e.g. 216A, 216B, 216C, 216D, 216E, 216F and 216G) may be established employing a suitable radio access technology (RAT).

More specifically, as noted above, communications system 200 may comprise a multiple access system and may employ one or more channel access schemes, such as CDMA, TDMA, FDMA, OFDMA, SC-FDMA, combinations thereof, and/or the like. For example, base station 214A in the RAN 204 and WTRUs 202A, 202B, and 202C may implement a radio technology such as Universal Mobile Telecommunications System (UMTS) Terrestrial Radio Access (UTRA), which may establish air interface (e.g. 202A, 202B, and 202C) employing wideband CDMA (WCDMA). WCDMA may comprise communication protocols such as High-Speed Packet Access (HSPA) and/or Evolved HSPA (HSPA+). HSPA may comprise High-Speed Downlink Packet Access (HSDPA) and/or High-Speed Uplink Packet Access (HSUPA).

According to an embodiment, base station 214A and WTRUs 202A, 202B, 202C may implement a radio technology such as Evolved UMTS Terrestrial Radio Access (E-UTRA), which may establish air interface (e.g. 216A, 216B, and 216C, respectively) employing Long Term Evolution (LTE) and/or LTE-Advanced (LTE-A).

According to an embodiment, base station 214A and WTRUs 202A, 202B, 202C may implement radio technologies such as IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), combinations thereof, and/or the like.

Base station 214B in FIG. 2 may comprise a wireless router, Home Node B, Home eNode B, or an access point, for example, and may utilize a RAT for facilitating wireless connectivity in a localized area, such as a place of business, a home, a vehicle, a campus, combinations thereof, and/or the like. According to an embodiment, base station 214B and WTRUs 202C, 202D may implement a radio technology such as IEEE 802.11 to establish a wireless local area network (WLAN). According to an embodiment, base station 214B and WTRUs 202C and 202D may implement a radio technology such as IEEE 802.15 to establish a wireless personal area network (WPAN). According to an embodiment, base station 214B and WTRUs 202C and 202D may utilize a cellular-based RAT (e.g., WCDMA, CDMA2000, GSM, LTE, LTE-A, etc.) to establish a picocell or femtocell. As shown in FIG. 2, base station 214B may have a direct connection to the Internet 210. Thus, base station 214B may not be required to access the Internet 210 via the core network 206.

The RAN 204 may be in communication with the core network 206, which may be a type of network configured to provide voice, data, applications, and/or voice over internet protocol (VoIP) services to one or more of the WTRUs 202A, 202B, 202C, and 202D. For example, core network 206 may provide call control, billing services, mobile location-based services, pre-paid calling, Internet connectivity, video distribution, etc., and/or perform high-level security functions, such as user authentication. Although not shown in FIG. 2, it anticipated that according to an embodiment, RAN 204 and/or core network 206 may be in direct or indirect communication with other RANs that employ the same RAT as the RAN 204 or a different RAT. For example, in addition to being connected to the RAN 204, which may utilize an E-UTRA radio technology, the core network 206 may also be in communication with another RAN (not shown).

Core network 206 may serve as a gateway for the WTRUs 202A, 202B, 202C and/or 202D to access the PSTN 208, the Internet 210 and/or other networks 212. The Internet 210 may comprise a global system of interconnected computer networks and devices that use common communication protocols, such as the transmission control protocol (TCP), user datagram protocol (UDP) and the internet protocol (IP) in the TCP/IP internet protocol suite. Other networks 212 may comprise wired and/or wireless communications networks owned and/or operated by other service providers. For example, the networks 212 may comprise another core network connected to one or more RANs, which may employ the same RAT as the RAN 204 or a different RAT.

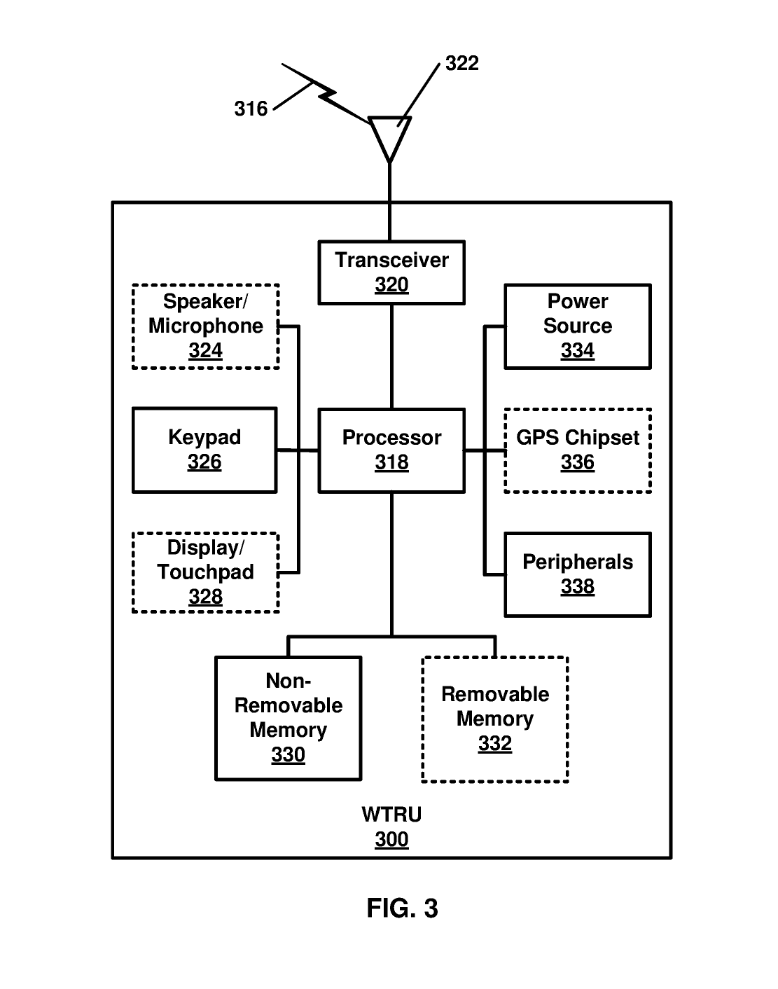

Some or all of the WTRUs 202A, 202B, 202C, and 202D in the communications system 200 may comprise multi-mode capabilities (i.e., the WTRUs 202A, 202B, 202C, and 202D may comprise multiple transceivers for communicating with different wireless networks over different wireless links). For example, example WTRU 300 shown in FIG. 3 may be configured to communicate with base station 214A, which may employ a cellular-based radio technology, and with the base station 214B, which may employ an IEEE 802 radio technology.

FIG. 3 is a system diagram of an example WTRU 300. As shown in FIG. 3, example WTRU 300 may comprise a processor 318, a transceiver 320, a transmit/receive element 322, a speaker/microphone 324, a keypad 326, a display/touchpad 328, non-removable memory 330, removable memory 332, a power source 334, a global positioning system (GPS) chipset 336, and other peripherals 338. It will be appreciated that the WTRU 300 may comprise a sub-combination of the foregoing elements while remaining consistent with an embodiment. For example, an WRTU 300 embodiment may be implemented without one or more of the dashed elements 324, 328, 336 and/or 332.

The processor 318 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. Processor 318 may perform signal coding, data processing, power control, input/output processing and/or other functionality that enables example WTRU 300 to operate in a wireless environment. Processor 318 may be coupled to the transceiver 320, which may be coupled to the transmit/receive element 322. While FIG. 3 depicts elements such as, for example, processor 318 and transceiver 320 as separate components, it will be appreciated that the elements such as processor 318 and the transceiver 320 may be integrated together in an electronic package and/or chip. While FIG. 3 depicts elements such as, for example, processor 318 and transceiver 320 as individual components, it will be appreciated that the elements such as processor 318 and the transceiver 320 may be implemented as a collection of other elements.

The transmit/receive element 322 may be configured to transmit signals to, or receive signals from, a base station (e.g., the base station 214A) over the air interface 316. For example, in an embodiment, the transmit/receive element 322 may be an antenna configured to transmit and/or receive RF signals. According to an embodiment, the transmit/receive element 322 may be an emitter/detector configured to transmit and/or receive IR, UV, or visible light signals, for example. According to an embodiment, the transmit/receive element 322 may be configured to transmit and receive both RF and light signals. It will be appreciated that the transmit/receive element 322 may be configured to transmit and/or receive any combination of wireless signals.

In addition, although the transmit/receive element 322 is depicted in FIG. 3 as a single element, example WTRU 300 may comprise any number of transmit/receive elements 322. More specifically, example WTRU 300 may employ MIMO technology. Thus, according to an embodiment, example WTRU 300 may comprise two or more transmit/receive elements 322 (e.g., multiple antennas) for transmitting and receiving wireless signals over the air interface 316.

Transceiver 320 may be configured to modulate signals that are to be transmitted by transmit/receive element 322 and to demodulate signals received by transmit/receive element 322. As noted above, example WTRU 300 may have multi-mode capabilities. Thus, the transceiver 320 may comprise multiple transceivers for enabling example WTRU 300 to communicate via multiple RATs, such as E-UTRA and IEEE 802.11, for example.

Processor 318 of example WTRU 300 may be coupled to, and may receive user input data from, for example, the speaker/microphone 324, the keypad 326 and/or the display/touchpad 328 (e.g., a liquid crystal display (LCD) display unit or organic light-emitting diode (OLED) display unit). Processor 318 may output user data to, for example, the speaker/microphone 324, the keypad 326 and/or the display/touchpad 328. Processor 318 may access information from, and store data in, a type of suitable memory, such as the non-removable memory 330 and/or the removable memory 332. The non-removable memory 330 may comprise random-access memory (RAM), read-only memory (ROM), a hard disk, and/or other type of memory storage device. The removable memory 332 may comprise a subscriber identity module (SIM) card, a memory stick, a secure digital (SD) memory card, and/or the like. According to an embodiment, processor 318 may access information from, and store data in, memory that is not physically located on example WTRU 300, such as on a server or a home computer (not shown).

Processor 318 may receive power from the power source 334, and may be configured to distribute and/or control the power to the other components in example WTRU 300. Power source 334 may be a suitable device for powering example WTRU 300. For example, power source 334 may comprise one or more dry cell batteries (e.g., nickel-cadmium (NiCd), nickel-zinc (NiZn), nickel metal hydride (NiMH), lithium-ion (Li-ion), etc.), solar cells, fuel cells, combinations thereof, and/or the like.

Processor 318 may also be coupled to GPS chipset 336, which may be configured to provide location information (e.g., longitude and latitude) regarding the current location of example WTRU 300. In addition to, and/or in lieu of, the information from the GPS chipset 336, example WTRU 300 may receive location information over the air interface 316 from a base station (e.g., base stations 214A, 214B) and/or determine a location based on the timing of the signals being received from two or more nearby base stations. It will be appreciated that the WTRU 300 may acquire location information by way of other suitable location-determination process(es) while remaining consistent with an embodiment.

Processor 318 may further be coupled to other peripherals 338, which may comprise one or more software and/or hardware modules that provide additional features, functionality, and/or wired or wireless connectivity. For example, peripherals 338 may comprise, for example, an accelerometer, an e-compass, a satellite transceiver, a digital camera (for photographs or video), a universal serial bus (USB) port, a vibration device, a television transceiver, a hands free headset, a Bluetooth™ module, a frequency modulated (FM) radio unit, a digital music player, a media player, a video game player module, an Internet browser, a combination thereof, and/or the like.

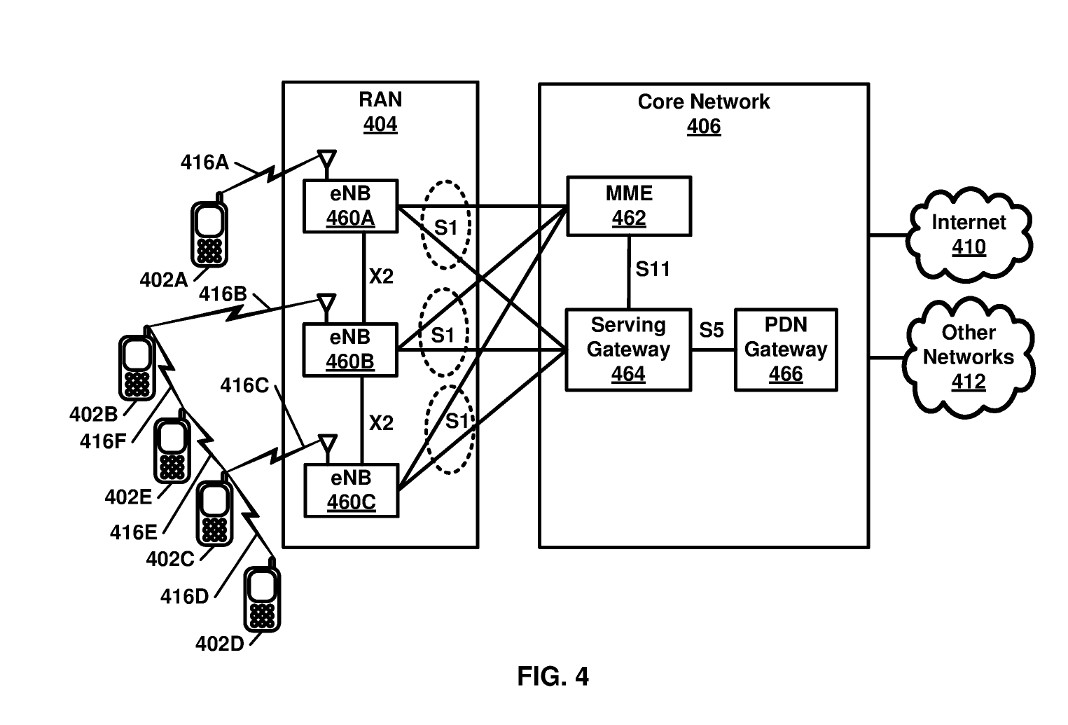

FIG. 4 is a system diagram of an example communications system comprising an example RAN 404 and an example core network 406. This example communications system is disclosed for example purposes. Variations in communications systems may be implemented within the scope of the embodiment. In this example embodiment, RAN 404 may employ an E-UTRA radio technology to communicate with the WTRUs 402A, 402B and/or 402C over air interfaces 416A, 416b and/or 416C respectively. RAN 404 may be in communication with the core network 406.

Example RAN 404 may comprise eNBs 460A, 460B and/or 460C, though it will be appreciated that the RAN 404 may comprise various numbered of eNBs while remaining consistent with an embodiment. The eNBs 460A, 460B and/or 460C may each comprise one or more transceivers for communicating with the WTRUs 402A, 402B and/or 402C over air interface 416A, 416B and/or 416C respectively. In an embodiment, the eNBs 460A, 460B and/or 460C may implement MIMO technology. Thus, the eNB 460A, for example, may use multiple antennas to transmit wireless signals to, and receive wireless signals from, example WTRUs 402A.

Some WTRUs may be configured to communicate with each other directly. For example, as illustrated, WTRU 402E may be configured to communicate with example WTRU 402B and/or example WTRU 402C over the air interfaces 416F and/or 416E, respectively. Similarly, example WTRU 402D may be configured to communicate with example WTRU 402C over the air interfaces 416D.

Each of the eNBs 460A, 460B, and/or 460C may be associated with a particular cell (not shown) and may be configured to handle radio resource management decisions, handover decisions, scheduling of users in the uplink and/or downlink, and the like. As shown in FIG. 4, the eNBs 460A, 460B and/or 460C may communicate with one another over, for example: an X2 interface, a reference point, and/or the like.

Example core network 406 shown in FIG. 4 may comprise a mobility management gateway (MME) 462, a serving gateway 464, a packet data network (PDN) gateway 466, and/or the like. While each of the foregoing elements are depicted as part of the core network 406, it will be appreciated that various elements operating in a core network (e.g. 406) may be owned and/or operated by an entity other than the core network operator.

The MME 462 may be connected to each of the eNBs 460A, 460B, 460C in RAN 404 via an S1 interface, a reference point, and/or the like and may serve as a control node. For example, the MME 462 may be responsible for authenticating users of the WTRUs 402A, 402B, 402C, 402D and/or 402E, bearer activation/deactivation, selecting a particular serving gateway during an initial attach of the WTRUs 402A, 402B, 402C, 402D and/or 402E, and/or the like. The MME 462 may also provide a control plane function for switching between the RAN 404 and other RANs (not shown) that employ other radio technologies, such as, for example, GSM and/or WCDMA.

Serving gateway 464 may be connected to each of the eNode Bs 460A, 460B and/or 460C in the RAN 404 via an S1 interface, a reference point, and/or the like. The serving gateway 464 may generally route and forward user data packets to and from the WTRUs 402 a, 402B and/or 402C. The serving gateway 464 may also perform other functions, such as anchoring user planes during inter-eNode B handovers, triggering paging when downlink data is available for the WTRUs 402A, 402B and/or 402C, managing and storing contexts of the WTRUs 402A, 402B and/or 402C, and/or the like.

The serving gateway 464 may also be connected to the PDN gateway 466, which may provide the WTRUs 402a, 402B and/or 402C with access to packet-switched networks, such as the Internet 410, to facilitate communications between the WTRUs 402A, 402B and/or 402C and IP-enabled devices.

Example core network 406 may facilitate communications with other networks. For example, core network 406 may provide the WTRUs 402A, 402B and 402C with access to circuit-switched networks to facilitate communications between the WTRUs 402A, 402B, 402C and traditional land-line communications devices. For example, the core network 406 may comprise, and/or may communicate with, an IP gateway (e.g., an IP multimedia subsystem (IMS) server) that serves as an interface between the core network 406 and a PSTN. In addition, the core network 406 may provide the WTRUs 402A, 402B, 402C with access to the networks 412, which may comprise other wired or wireless networks that are owned and/or operated by other service providers.

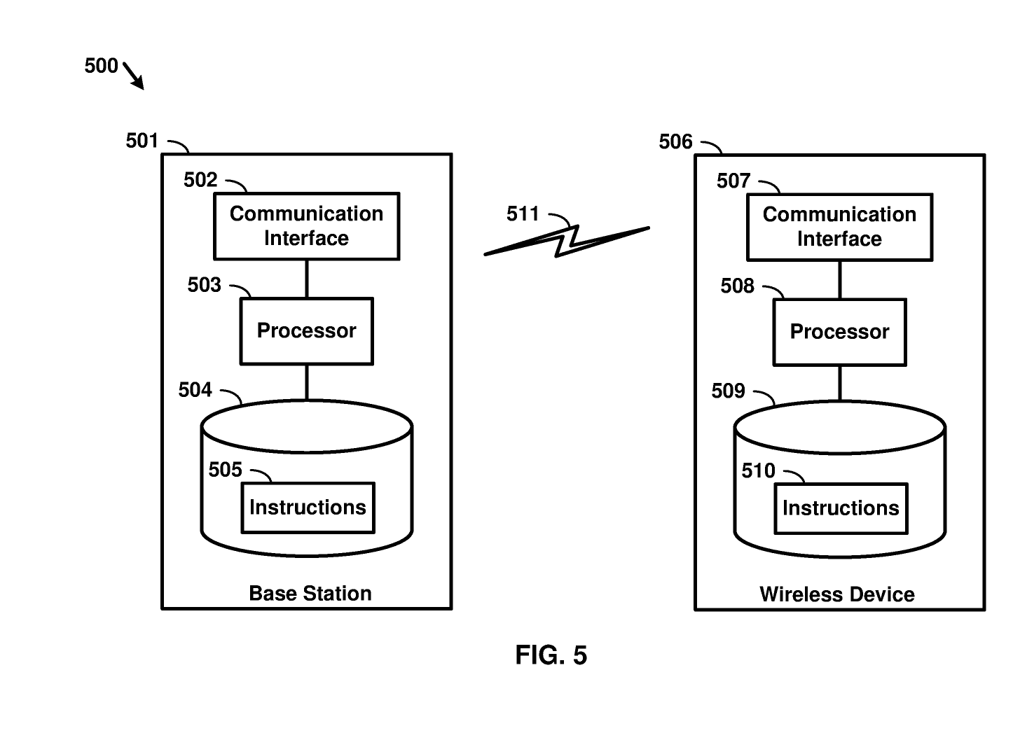

FIG. 5 is an example block diagram of a base station 501 and a wireless device 506, as per an aspect of an embodiment of the present invention. A communication network 500 may comprise at least one base station 501 and at least one wireless device 506. The base station 501 may comprise at least one communication interface 502, at least one processor 503, and at least one set of program code instructions 505 stored in non-transitory memory 504 and executable by the at least one processor 503. The wireless device 506 may comprise at least one communication interface 507, at least one processor 508, and at least one set of program code instructions 510 stored in non-transitory memory 509 and executable by the at least one processor 508. Communication interface 502 in base station 501 may be configured to engage in communication with communication interface 507 in wireless device 506 via a communication path that comprises at least one wireless link 511. Wireless link 511 may be a bi-directional link. Communication interface 507 in wireless device 506 may also be configured to engage in a communication with communication interface 502 in base station 501. Base station 501 and wireless device 506 may be configured to send and receive data over wireless link 511 using multiple frequency carriers. According to some of the various aspects of embodiments, transceiver(s) may be employed. A transceiver is a device that comprises both a transmitter and receiver. Transceivers may be employed in devices such as wireless devices, base stations, relay nodes, and/or the like.

An interface may be a hardware interface, a firmware interface, a software interface, and/or a combination thereof. The hardware interface may comprise connectors, wires, electronic devices such as drivers, amplifiers, and/or the like. A software interface may comprise code stored in a memory device to implement protocol(s), protocol layers, communication drivers, device drivers, combinations thereof, and/or the like. A firmware interface may comprise a combination of embedded hardware and code stored in and/or in communication with a memory device to implement connections, electronic device operations, protocol(s), protocol layers, communication drivers, device drivers, hardware operations, combinations thereof, and/or the like.

The term configured may relate to the capacity of a device whether the device is in an operational or non-operational state. Configured may also refer to specific settings in a device that effect the operational characteristics of the device whether the device is in an operational or non-operational state. In other words, the hardware, software, firmware, registers, memory values, and/or the like may be “configured” within a device, whether the device is in an operational or nonoperational state, to provide the device with specific characteristics. Terms such as “a control message to cause in a device” may mean that a control message has parameters that may be used to configure specific characteristics in the device, whether the device is in an operational or non-operational state.

According to some of the various aspects of embodiments, an LTE network may comprise a multitude of base stations, providing a user plane PDCP/RLC/MAC/PHY and control plane (RRC) protocol terminations towards the wireless device. The base station(s) may be interconnected with other base station(s) (e.g. employing an X2 interface, reference point, and/or the like). The base stations may also be connected employing, for example, an S1 interface to an EPC. For example, the base stations may be interconnected to the MME employing the S1-MME interface, reference point, and/or the like and to the Serving Gateway (S-G) employing the S1-U reference point. The S1 interface, reference point, and/or the like may support a many-to-many relation between MMEs/Serving Gateways and base stations. A base station may comprise many sectors for example: 1, 2, 3, 4, or 6 sectors. A base station may comprise many cells, for example, ranging from 1 to 50 cells or more. A cell may be categorized, for example, as a primary cell or secondary cell. At RRC connection establishment/re-establishment/handover, one serving cell may provide the NAS (non-access stratum) mobility information (e.g. TAI), and at RRC connection re-establishment/handover, one serving cell may provide the security input. This cell may be referred to as the Primary Cell (PCell). In the downlink, the carrier corresponding to the PCell may be the Downlink Primary Component Carrier (DL PCC), while in the uplink, it may be the Uplink Primary Component Carrier (UL PCC). Depending on wireless device capabilities, Secondary Cells (SCells) may be configured to form together with the PCell a set of serving cells. In the downlink, the carrier corresponding to an SCell may be a Downlink Secondary Component Carrier (DL SCC), while in the uplink, it may be an Uplink Secondary Component Carrier (UL SCC). An SCell may or may not have an uplink carrier.

A cell, comprising a downlink carrier and optionally an uplink carrier, may be assigned a physical cell ID and a cell index. A carrier (downlink or uplink) may belong to only one cell. The cell ID or Cell index may also identify the downlink carrier or uplink carrier of the cell (depending on the context it is used). In the specification, cell ID may be equally referred to a carrier ID, and cell index may be referred to carrier index. In implementation, the physical cell ID or cell index may be assigned to a cell. A cell ID may be determined using a synchronization signal transmitted on a downlink carrier. A cell index may be determined using RRC messages. For example, when the specification refers to a first physical cell ID for a first downlink carrier, the specification may mean the first physical cell ID is for a cell comprising the first downlink carrier. The same concept may apply to, for example, carrier activation. When the specification indicates that a first carrier is activated, the specification may equally mean that the cell comprising the first carrier is activated.

Embodiments may be configured to operate as needed. The disclosed mechanism may be performed when certain criteria are met, for example, in a wireless device, a base station, a radio environment, a network, a combination of the above, and/or the like. Example criteria may be based, at least in part, on for example, traffic load, initial system set up, packet sizes, traffic characteristics, a combination of the above, and/or the like. When the one or more criteria are met, various example embodiments may be applied. Therefore, it may be possible to implement example embodiments that selectively implement disclosed protocols.

A base station may communicate with a mix of wireless devices. Wireless devices may support multiple technologies, and/or multiple releases of the same technology. Wireless devices may have some specific capability(ies) depending on its wireless device category and/or capability(ies). A base station may comprise multiple sectors. When this disclosure refers to a base station communicating with a plurality of wireless devices, this disclosure may refer to a subset of the total wireless devices in a coverage area. This disclosure may refer to, for example, a plurality of wireless devices of a given LTE release with a given capability and in a given sector of the base station. The plurality of wireless devices in this disclosure may refer to a selected plurality of wireless devices, and/or a subset of total wireless devices in a coverage area which perform according to disclosed methods, and/or the like. There may be a plurality of wireless devices in a coverage area that may not comply with the disclosed methods, for example, because those wireless devices perform based on older releases of LTE technology.

In order to set up a session for a mission critical service (MCS), where the mission critical service may be mission critical push-to-talk (MCPTT), the MCS UEs affiliated to MCS groups may first discover each other. This discovery may be a restricted discovery since MCS is a public safety feature. In the restricted discovery, the discoverer UEs and discoveree UEs may be authorized by being pre-provisioned with one or more parameters for the discovery procedure.

Examples for ProSe direct discovery methods are Model A and Model B.

Model A may include the following examples two roles for the ProSe-enabled UEs that are participating in ProSe Direct Discovery: Announcing UE: a) The UE announces certain information that may be used by UEs in proximity that have permission to discover. b) Monitoring UE: The UE that monitors certain information of interest in proximity of announcing UEs.

In Model A the announcing UE may broadcast discovery messages at discovery intervals (e.g. pre-defined intervals) and the monitoring UEs that are interested in these messages may read them and may process them. In an example, this model may be equivalent to “I am here” since the announcing UE may broadcast information about itself e.g. its restricted ProSe application code in the discovery message.

The UE may act as “announcing UE” in the carrier frequency signaled by the serving PLMN when using Model A mode. The UE may act as a “monitoring” UE in the resources of the serving PLMN and Local PLMNs, when using Model A mode. When inter-PLMN discovery transmission is supported, the carrier frequency may be operated by a PLMN other than the serving PLMN. Open and/or restricted discovery types may be supported by Model A.

Model B, when restricted discovery type is used, includes the following examples two roles for the ProSe-enabled UEs that are participating in ProSe Direct Discovery: a) Discoverer UE: The UE transmits a request containing certain information about what it is interested to discover. b) Discoveree UE: The UE that receives the request message may respond with some information related to the discoverer's request.

In an example, it is equivalent to “who is there/are you there”. The discoverer UE sends information about other UEs that may like to receive responses from, e.g. the information may be about a ProSe application identity corresponding to a group and the members of the group may respond.

When using Model B discovery, the discoverer UE and discoveree UE may announce in the carrier frequency signaled by the serving PLMN. When inter-PLMN discovery transmission is supported, the carrier frequency may be operated by a PLMN other than the serving PLMN. The discoverer UE and discoveree UE may be allowed to monitor in the serving PLMN and Local PLMNs when authorized. In an example implementation, only restricted discovery type may support by Model B. In an example application, the public safety discovery may be considered restricted. The monitoring UE/discoverer UE may need to have authorization (such as through pre-provisioned parameters) to perform discovery of the appropriate service(s).

The public safety discovery is considered restricted and depending on Model A or Model B, it may use ProSe restricted code for Model A, it may use ProSe query code/ProSe response code respectively for Model B.

These code parameters may be n bits, e.g. 64 bits, and may be part of ProSe Application Code. They may correspond to one or more restricted ProSe application user ID(s) (RPAUID). The ProSe application user ID may be allocated and bound to ProSe discovery UE ID (PDUID) by the ProSe application server.

FIG. 6 is an example of a ProSe Discovery message which may be employed for discovery procedures in Model A and Model B. In Model A, the announcing MCS UE may use ProSe restricted code and if the application-controlled extension is used, it may use ProSe restricted code prefix and ProSe restricted code suffix(es) to announce its identity over the PC5 interface. The monitoring MCS UE may use discovery filter which may be provided by the HPLMN ProSe function comprising the ProSe restricted code (or ProSe restricted code prefix with ProSe Restricted Code suffix pool if restricted direct discovery with application-controlled extension was requested by the announcing MCS UE) to monitor the announcing MCS UE for a duration of time.

Model A may compromise a procedure for the announcing MCS UE and a procedure for the monitoring MCS UE. It may include a matching procedure for the case when the monitoring MCS UE receives ProSe restricted code over the air that matches the discovery filter provided by the HPLMN ProSe function to the monitoring MCS UE in the discovery response message, however the corresponding restricted ProSe application UE identity (RPAUID) does not have valid validity timer.

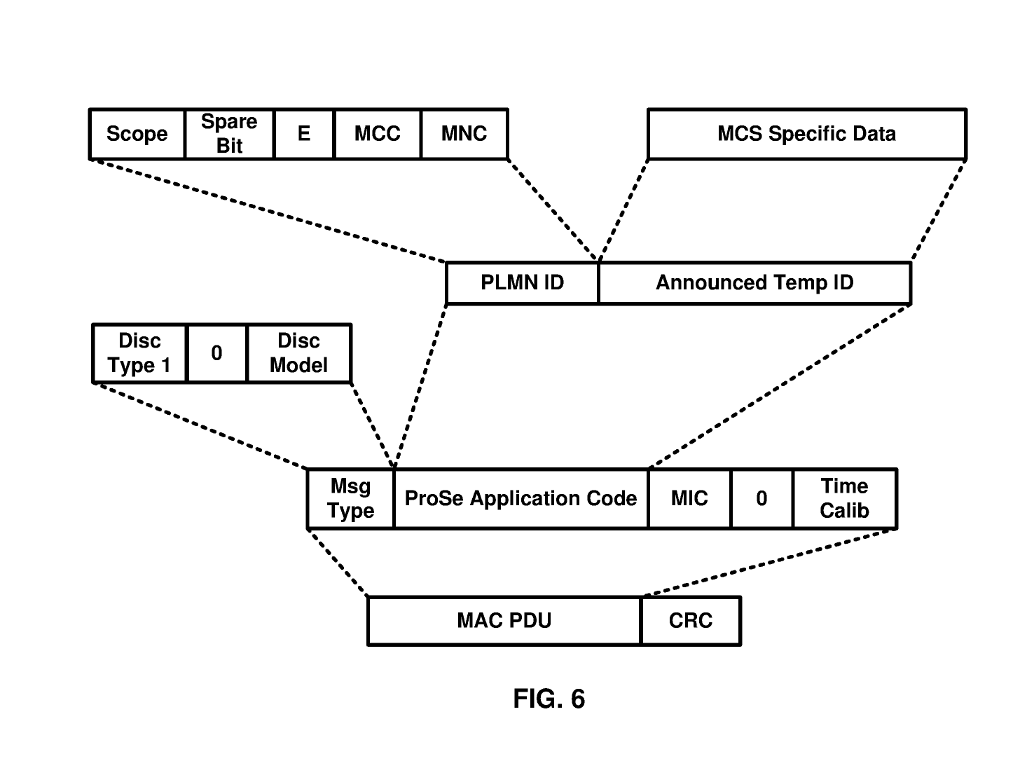

FIG. 7 is a flow diagram of an example procedure for Model A discovery. This example procedure for the Model A discovery may include one or more of the following:

Authorization: The MCS UE may get authorized for restricted ProSe direct discovery. In an example, MCS may be public safety and the ProSe direct discovery may be restricted.

Announcement: The announcing MCS UE may request for discovery and may receive the ProSe restricted code (or ProSe restricted code prefix and ProSe restricted code suffix(es) to announce itself, if the application-controlled extension is used). The announcing MCS UE may announce the ProSe restricted code (or ProSe restricted code prefix and ProSe restricted code suffix(es) to announce itself, if the application-controlled extension is used).

Monitoring: The monitoring MCS UE may request for discovery and may receive the ProSe Filter comprising the ProSe Restricted Code (or ProSe Restricted Code Prefix and ProSe Restricted Code Suffix(es) to announce itself, if the application-controlled extension is used). The monitoring MCS UE may monitor for the ProSe restricted code (or ProSe restricted code prefix and ProSe restricted code suffix(es) to announce itself, if the application-controlled extension is used).

Match-Reporting: The monitoring UE may match-report if having monitored ProSe restricted code (or ProSe restricted code prefix and ProSe restricted code suffix(es) to announce itself, if the application-controlled extension is used) with corresponding PRAUID with no valid validity timer.

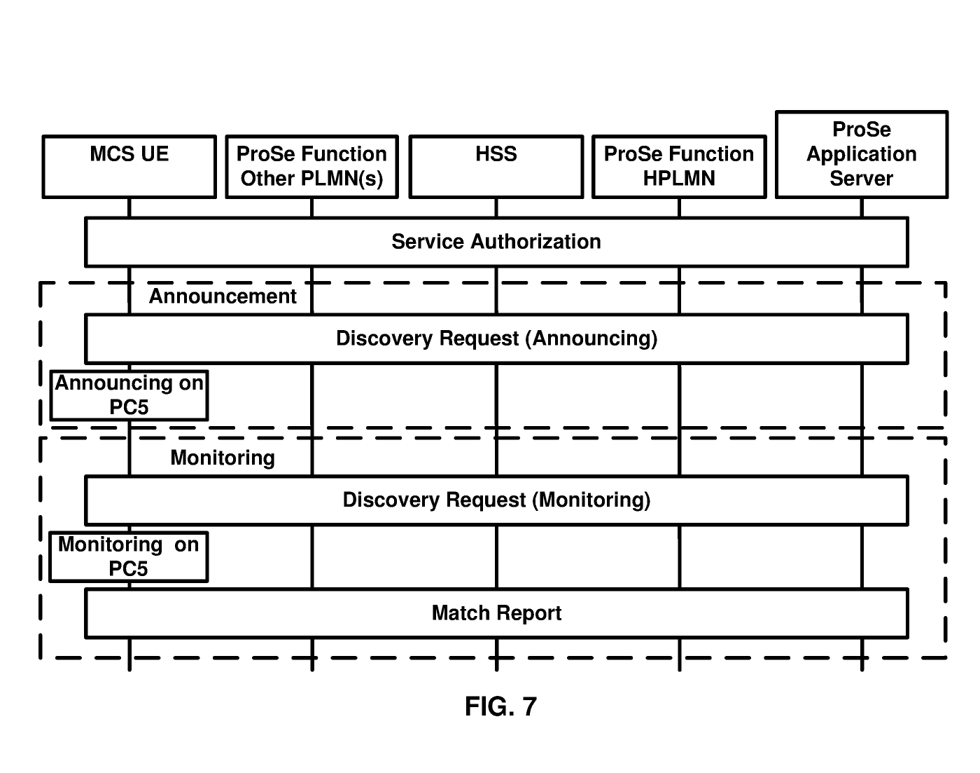

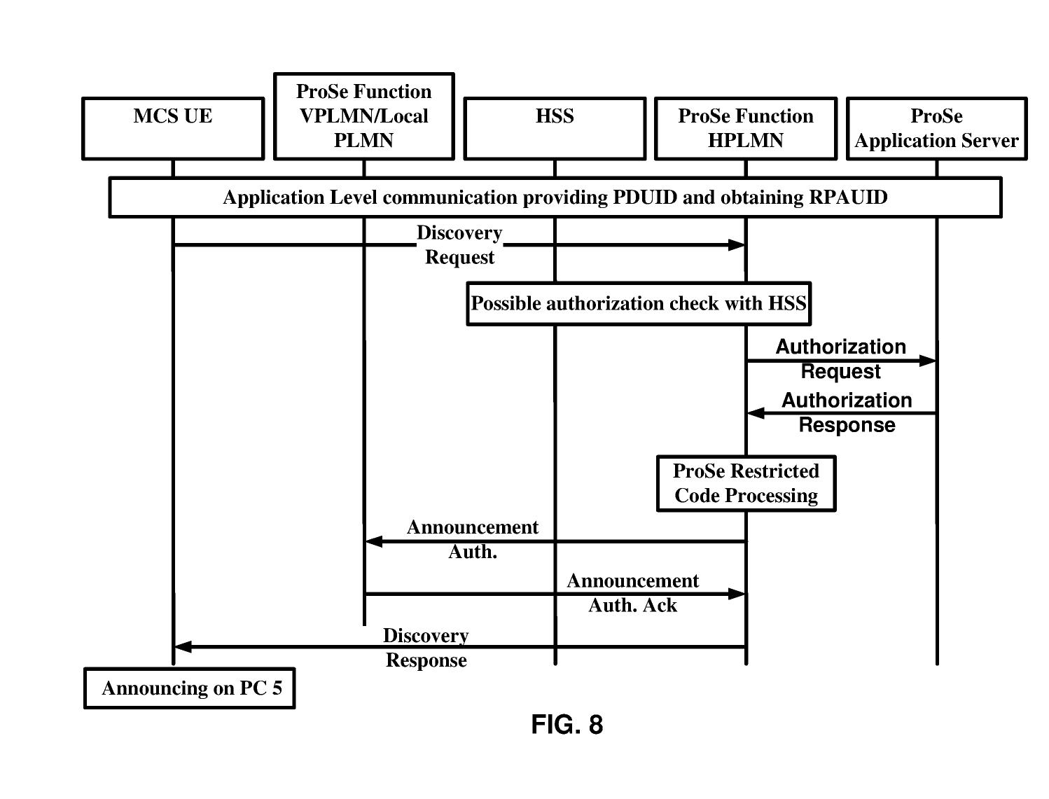

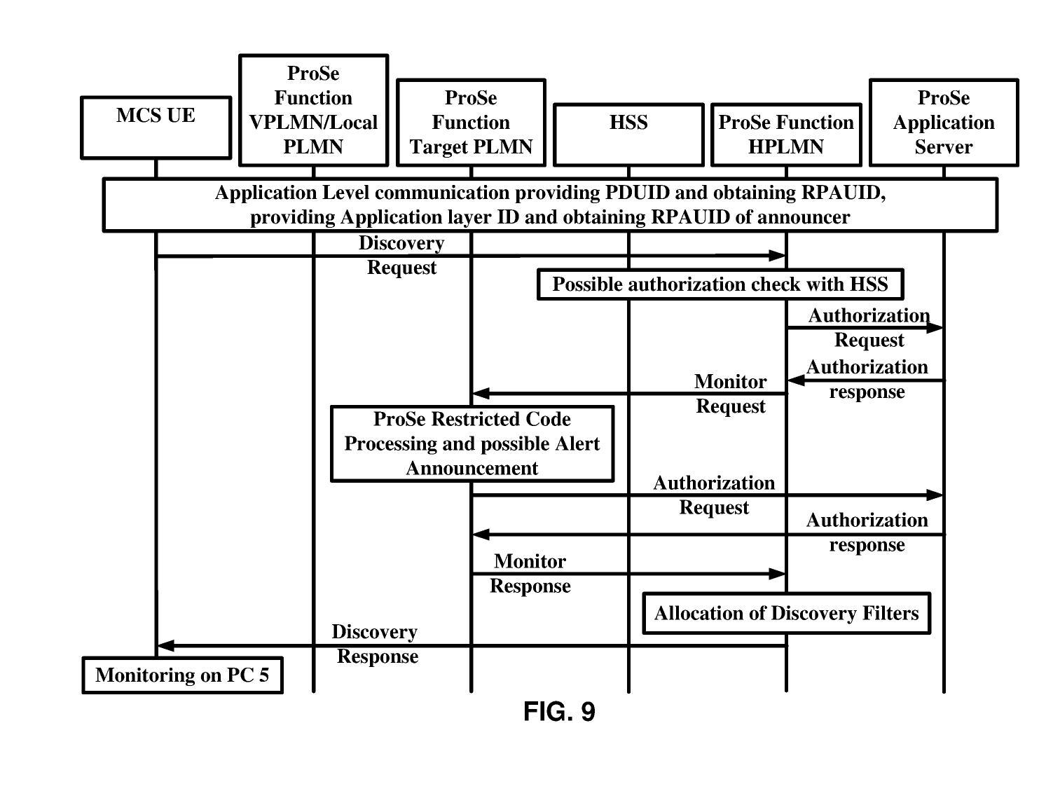

The announcing, monitoring, and match-reporting procedures are explained below. FIG. 8, FIG. 9, and FIG. 10.

FIG. 8 is a flow diagram showing an example procedures for the announcing MCS UE. An example procedure for the announcing MCS UE is as follows:

The application client in the MCS UE may retrieve the ProSe discovery UE identity (PDUID) and may provide it to the ProSe application server. The ProSe application server may allocate a restricted ProSe application UE identity (RPAUID) for that PDUID, may store the binding between the PDUID and the RPAUID and may return the RPAUID to the application client in the MCS UE. MCS UE may use RPAUID instead of PDUID since MCS is a public safety feature.

MCS UE may construct a discovery request message containing RPAUID, UE identity set to international mobile subscriber identity (IMSI), command=announce, discovery type set to restricted discovery, application ID set to unique identifier of the MCS application ID, discovery entry ID indicating if this is a new request, optional requested discovery timer set to validity timer associated with the expected ProSe restricted code from the HPLMN ProSe Function (if it is set to zero, the MCS UE is requesting to remove the discovery entity ID and release the associated resources), (if application-controlled extension is used) application level container containing the request and the relevant information, announcing type such as “on demand” for the indicated application, and the PLMN ID of the carrier frequency in announcing PLMN ID if the serving PLMN signaled carrier frequency is not operated by HPLMN or VPLMN and if inter-PLMN ProSe discovery transmission is supported. MCS UE may send the discovery request message to HPLMN ProSe function.

HPLMN ProSe function may check for authorization for the MCS application. If there is not any associated MCS UE context, the HPLMN ProSe function may check with HSS and if needed may create a new context for the MCS UE that contains the subscription parameters for this MCS UE. HSS may provide MSISDN of the MCS UE and PLMN ID of where the MCS UE is registered.

The HPLMN ProSe function may send an authorization request containing RPAUID and request type set to “restricted discovery/announce” towards the ProSe application server. The authorization request may contain allowed number of suffixes if restricted Direct Discovery with application-controlled extension is used. The request type is set to “restricted discovery with application-controlled extension/announce”.

The ProSe application server may answer by an authorization response containing PDUID(s) corresponding the RPAUID stored in the ProSe application server and response type set to “restricted discover/announce ack”. The authorization respond may include ProSe restricted code suffix pool with allocated suffixes by the ProSe Application if restricted direct discovery with application-controlled extension is used. The response type is set to “restricted discovery with application-controlled extension/announce ack”.

HPLMN ProSe function may assign a ProSe restricted code corresponding to the RPAUID in the discovery request and an associated validity timer which identifies the duration of validity of the ProSe restricted code. MCS UE may use this ProSe restricted code within this validity duration if PLMN is not changed. If restricted direct discovery with application-controlled is used, then HPLMN ProSe functions may assign ProSe restricted code prefix instead of ProSe restricted code. If discovery request message indicates “on demand” announcing and the “on demand” announcing is authorized and enabled based on application ID and operator's policy, the HPLMN ProSe function may store RPAUID, ProSe restricted code (or ProSe restricted code prefix) with the associated validity timer, and enabled indicator in the user context. “On demand” announcing is only activated based on an ongoing monitoring request, otherwise, the following steps are not executed.

If the Discovery request is authorized, HPLMN ProSe Function may construct announce authorization message containing RPAUID, MCS application ID, ProSe restricted code (or ProSe restricted code prefix with ProSe restricted code suffix pool if restricted direct discovery with application-controlled extension is used) set to assigned code for this request, UE ID set to IMSI or mobile station identifier number (MSISDN), discovery entry ID, and validity timer. The HPLMN ProSe function may update the existing announcing MCS UE's discovery entry with the new ProSe restricted code (or the ProSe restricted code prefix with ProSe restricted code suffix pool if restricted direct discovery with application-controlled extension is used) and the new validity timer by using the MCS UE's corresponding discovery entry ID included in the discovery request message. If discovery request message included discovery timer set to zero for a discovery entity ID, then the HPLMN ProSe function may inform the VPLMN ProSe function to remove resources for that discovery entry ID by setting the timer to zero. The HPLMN ProSe function may send the announce authorization message towards the VPLMN ProSe Function.

The VPLMN ProSe function may acknowledge the HPLMN ProSe function that it authorizes the MCS UE to perform restricted discovery announcing if the announce authorization message contain a new discovery entry ID. If the discovery entry ID already exists, the VPLMN ProSe function may acknowledge the update as requested.

If the announcing is not “on-demand”, the HPLMN ProSe function may construct a discovery respond message with ProSe restricted code (or ProSe restricted code prefix with ProSe restricted code suffix pool if restricted direct discovery with application-controlled extension is used), validity timer, and discovery entity ID. If the announcing is “on-demand” and is authorized and enabled, the HPLMN ProSe function may construct the discovery respond message with validity timer, announcing enabled indicator, and discovery entity ID. The validity timer is set to zero if it is zero in discovery request message originated by the MCS UE. The HPLMN ProSe function may send the discovery respond message towards the MCS UE.

MCS UE may start announcing the provided ProSe restricted code. if restricted direct discovery with application-controlled extension is used, the MCS UE may append a ProSe restricted code suffix from the received ProSe restricted code suffix pool to the ProSe Restricted Code Prefix to form a ProSe Restricted Code. The MCS UE may use different suffixes from the provided ProSe restricted code suffix pool to form and announce different ProSe restricted codes without having to contact the HPLMN ProSe function as long as the validity timer permits. If “on-demand” announcing is used and the HPLMN ProSe function has not provided ProSe restricted code (or ProSe restricted code prefix with ProSe restricted code suffix pool if restricted direct discovery with application-controlled extension is used), the MCS UE may need to wait for an announcing alert request message from the HPLMN ProSe function before announcing on PC5 interface.

FIG. 9 is a flow diagram showing an example procedures for the monitoring MCS UE. The example procedure for monitoring MCS UE is as follows:

The application client in the MCS UE may retrieve the ProSe discovery UE identity (PDUID) and may provide it to the ProSe application server. The ProSe application server may allocate a restricted ProSe application UE identity (RPAUID) for that PDUID, may store the binding between the PDUID and the RPAUID and may return the RPAUID to the application client in the MCS UE. The MCS UE may obtain RPAUIDs of those MCS target users from the ProSe Application Server passed in an application level container. RPAUID instead of PDUID is used since MCS is a public safety feature.

In order to get the discovery filter, the monitoring MCS UE may construct a discovery request message comprising RPAUID set to the monitoring MCS UE identity, UE identity set to IMSI, command=monitor, discovery type, application ID set to unique identifier for the application that triggered discovery procedure, application level container compromising the Target RPAUIDs that the MCS UE is to monitor, discovery entry ID showing the discovery identity that it is a new discovery or an existing one, and the optional requested discovery timer. The requested discovery timer may be set to zero to indicate HPLMN to delete the discovery filter(s) for that discovery entry ID. The application level container may include some information about ProSe restricted code suffix such as group or user specific information if direct discovery with application-controlled extension is used. The MCS UE may send the discovery request message towards HPLMN ProSe function.

HPLMN ProSe function may check for authorization for the MCS application. If there is not any associated MCS UE context, the HPLMN ProSe function may check with HSS and if needed may create a new context for the MCS UE that contains the subscription parameters for this MCS UE. HSS provides also MSISDN of the MCS UE and PLMN ID of where the MCS UE is registered.

The HPLMN ProSe function may send an authorization request containing RPAUID and request type set to “restricted discovery/monitor” towards the ProSe application server. If restricted direct discovery with application-controlled extension is used, the request type is then set to “restricted discovery with application-controlled extension/monitor”.

The ProSe application server constructs an authorization response comprising target PDUIDs and corresponding Target RPAUID that the RPAUID in the authorization request may monitor, PDUID of the requesting MCS UE, and response type set to “restricted discovery/monitor ack” (or to “restricted discovery with application-controlled extension/monitor ack” if restricted direct discovery with application-controlled extension is used). The ProSe application server may send the authorization response towards the HPLMN ProSe function.

The HPLMN ProSe function may construct a monitor request message comprising RPAUID of monitoring MCS UE, UE identity set to IMSI or MSISDN, Target PDUID and corresponding target RPAUID, application ID set to unique identifier for application that triggered the discovery procedure, and discovery entry ID to identify the discovery entry being new or an existing one. The HPLMN ProSe function may send the monitor request towards the target PLMN ProSe function which belongs to the monitoring MCS UE. If the discovery entry ID is an existing one, the target PLMN ProSe function may modify the existing discovery procedure with the parameters included in the monitor request message.

The target PLMN ProSe function may retrieve the ProSe restricted code (or the ProSe restricted code prefix if the restricted direct discovery with application-controlled extension is used) corresponding to the targeted PDUID, targeted RPAUID, and application ID. If in the context of the announcing MCS UE, the announcing enabled indicator is stored, the target PLMN ProSe function may construct an announcing alert request message comprising RPAUID indicating which monitoring MCS UE is interested in the targeted MCS UE announcement, application ID set to unique identifier for the application that triggered discovery procedure, ProSe restricted code which was retrieved from the context of the targeted announcing MCS UE (or ProSe restricted code prefix with ProSe restricted code suffix pool if restricted direct discovery with application-controlled extension was requested by the announcing MCS UE), and discovery entry ID to indicate it is a new discovery entity or an existing one. The target PLMN PRoSe function may send the message towards the targeted MCS UE and upon receipt of the announce alert response message from that MCS announcing UE, the ProSe function removes the announcing enabled indication associated to the ProSe restricted code (or ProSe restricted code prefix with ProSe restricted code suffix pool if restricted direct discovery with application-controlled extension was requested by the announcing MCS UE) from the Announcing MCS UE context. The MCS UE may now start announcing the ProSe restricted code (or ProSe restricted code prefix with ProSe restricted code suffix pool if restricted direct discovery with application-controlled extension was requested by the announcing MCS UE).

The target ProSe function may construct an authorization request message comprising RPAUID set to that of the monitoring MCS UE, Request Type set to “restricted discovery/permission”, and target RPAUID set to that of the announcing MCS UE. The target ProSe function may send the authorization request message towards the ProSe application server.

The ProSe application server may acknowledge the target ProSe function by constructing an authorization response message comprising PDUID of the announcing MCS UE which is to be monitored and response type set to “restricted discovery/permission ack” and by sending it towards the target PLMN ProSe function.

The target ProSe function constructs a monitor response message compromising ProSe restricted code (or ProSe restricted code prefix with ProSe restricted code suffix pool if restricted direct discovery with application-controlled extension was requested by the announcing MCS UE) and the corresponding validity timer. The target ProSe function may send the monitor response message towards the HPLMN ProSe function.

From the ProSe application server, the HPLMN ProSe function has now retrieved the ProSe restricted code (or ProSe restricted code prefix with ProSe restricted code suffix pool if restricted direct discovery with application-controlled extension was requested by the announcing MCS UE) and the corresponding validity timer for each pair of target PDUID-target RPAUID bound with application ID and stored as the user content of the monitoring MCS UE. The HPLMN ProSe function based on the ProSe restricted code (or ProSe restricted code prefix with ProSe restricted code suffix pool if restricted direct discovery with application-controlled extension was requested by the announcing MCS UE) and the corresponding validity timer, allocates a discovery filter with corresponding time-to-live (TTL).

The HPLMN ProSe function may construct a discovery response message comprising target RPAUID(s) and the corresponding discovery filter(s) that comprises ProSe restricted code (or ProSe restricted code prefix with ProSe restricted code suffix pool if restricted direct discovery with application-controlled extension was requested by the announcing MCS UE) to be monitored and the corresponding TTL showing how long the filter is valid. If the requested discovery timer in discovery request message sent by MCS monitoring UE was set to zero, the TTL in the discovery response message is set to zero. The discovery response message also comprises discovery entry ID to identify the discovery entity. The HPLMN ProSe function may send the discovery response message towards the monitoring MCS UE.

The MCS UE uses the discovery filter to monitor the announcing MCS UE.

FIG. 10 is a flow diagram showing an example match reporting procedure. The example procedure for match reporting for announcing/monitoring is as follows:

If the monitoring MCS UE has over the air received a ProSe restricted code (or the ProSe restricted code prefix and the ProSe restricted code suffix if the restricted direct discovery with application-controlled extension is used) is matching the discovery filter obtained in the discovery response message from the HPLMN ProSe function but the announcing MCS UE does not have an RPAUID with a valid TTL, the monitoring MCS UE may construct a match report message comprising its own RPAUID, its IMSI or MSISDN as UE identity, discovery type set to “restricted discovery”, application ID set to unique identifier for the application that triggered the monitoring request, the over the air received ProSe restricted code, optional metadata requested, and announcing PLMN ID of the PLMN where the announcing MCS UE was monitored. The monitoring MCS UE transmits the match report message towards the HPLMN ProSe function.

The HPLMN ProSe function may verify if the monitoring MCS UE may perform restricted discovery and may analyze ProSe restricted code (or the ProSe restricted code prefix and the ProSe restricted code suffix if the restricted direct discovery with application-controlled extension is used). The HPLMN ProSe function may identify the announcing MCS UE's RPAUID in the context of the monitoring MCS UE.

If metadata requested was included to the originated match report message by the monitoring MCS UE, the HPLMN ProSe function may locate the ProSe application server from the application ID and may construct an authorization request message comprising monitoring MCS UE's RPAUID, announcing MCS UE's RPAUID, and request type set to “restricted discovery/match”. The HPLMN ProSe function may send the authorization request message towards the ProSe application server. This step is optional if metadata requested was not included into the original match report message.

The ProSe application server may construct an authorization response comprising monitoring MCS UE's PDUID, announcing MCS UE's PDUID, response type set to “restricted discovery/match ack”, and metadata corresponding to the Announcing MCS UE.

The HPLMN ProSe function may verify that the PDUID belongs to the monitoring MCS UE and the announcing MCS UE's PDUID are the same as the announcing MCS UE's PDUID that is stored in the context of the Monitoring MCS UE.

The HPLMN ProSe function may construct a match report ack comprising application ID set to unique identifier for the application that triggered the monitoring request, announcing MCS UE's RPAUID, validity timer, and optionally meta data.

The monitoring MCS UE may store the mapping between the ProSe restricted code (or the ProSe restricted code prefix and the ProSe restricted code suffix if the restricted direct discovery with application-controlled extension is used), announcing MCS UE's PRAUID, the application ID unique identifier of the application that triggered the monitoring procedure, and the related validity timer.

The HPLMN ProSe function may construct a Mach Report Info message comprising Monitoring MCS UE's RPAUID, announcing MCS UE's RPAUID, announcing MCS UE's identity set to IMSI or MSISDN for charging purposes, ProSe restricted code (or the ProSe restricted code prefix and the ProSe restricted code suffix if the restricted direct discovery with application-controlled extension is used), and discovery type set to “restricted discovery”. The HPLMN ProSe function may send the match report info message towards the announcing MCS UE's PLMN ProSe function and the ProSe function of the PLMN where the announcing MCS UE may be roaming in.

In Model B, the discoverer MCS UE may use ProSe query code to find the discoveree MCS UE. The discoveree MCS UE may use ProSe response code to identify itself. The ProSe response code is sent by the discoveree MCS UE over the air upon receiving a ProSe query code matching any discovery query filter(s). The discoverer MCS UE discovers then the discoveree MCS UE by matching the ProSe response code to any discovery response filter(s). The ProSe query code, and the discovery response filter(s) are allocated by HPLMN ProSe function to the discoverer MCS UE. The ProSe response code and discovery query filter(s) are allocated by the HPLMN ProSe function to the discoveree MCS UE.

Model B compromises procedure for the discoveree MCS UE and procedure for the discoverer MCS UE procedure. It may include matching procedure for the case when the discoverer MCS UE receives ProSe response code over the air that matches the discovery filter provided by the HPLMN ProSe function to the discoveree MCS UE in the discovery response message, however the corresponding RPAUID does not have valid validity timer. Model B is always for restricted discovery.

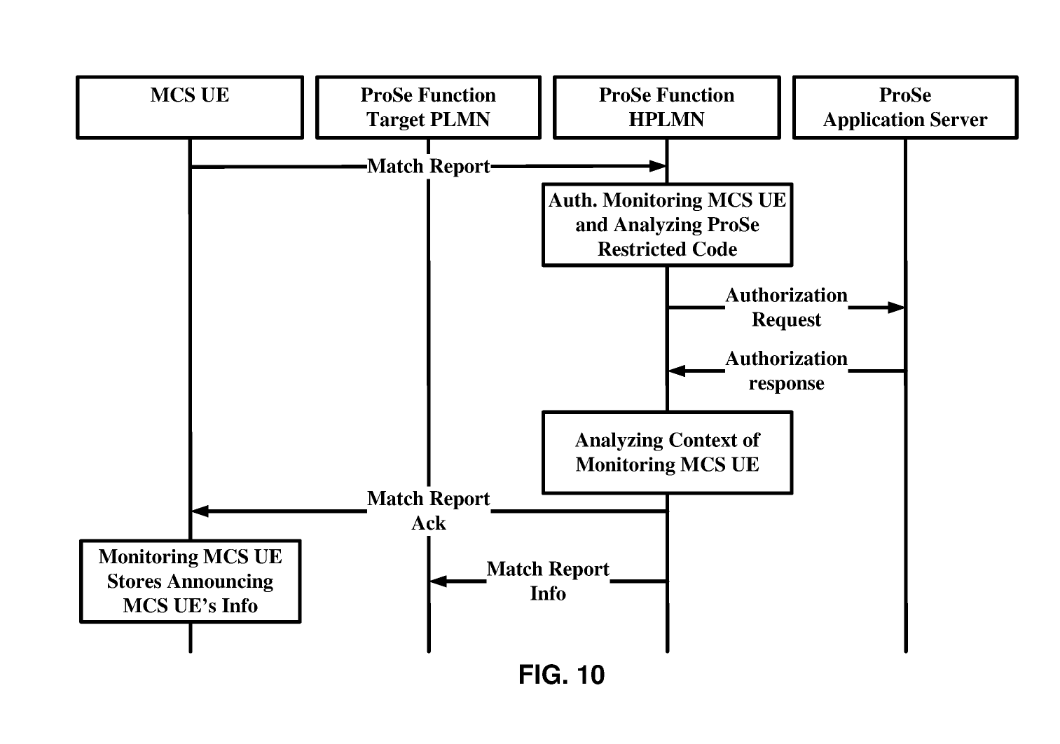

FIG. 11 is a flow diagram showing an example procedures for Model B discovery. The example procedure for the Model B discovery is as follows:

Authorization: The MCS UE may get authorized for restricted ProSe direct discovery. In an example, MCS may be public safety and the ProSe direct discovery may be restricted.

Discoveree procedure: The discoveree MCS UE may request for discovery and may receive the ProSe response code and associated discovery query filter(s). The discoveree MCS UE may employ the discovery filter(s) to monitor ProSe query code on PC5. The discoveree MCS UE may announce the ProSe response code if receiving a ProSe query code over the air which matches any of discovery filter(s).

Discoverer procedure: The discoverer MCS UE may request for discovery and may receive the ProSe query code and associated discovery response filter(s). The discoverer MCS UE may announce the ProSe query code on PC5 interface. The discoverer MCS UE may monitor ProSe response code on PC5 interface that may match any of the discovery response filter(s). The discoverer UE may match-report if having discovered ProSe response code with corresponding PRAUID with no valid validity timer.

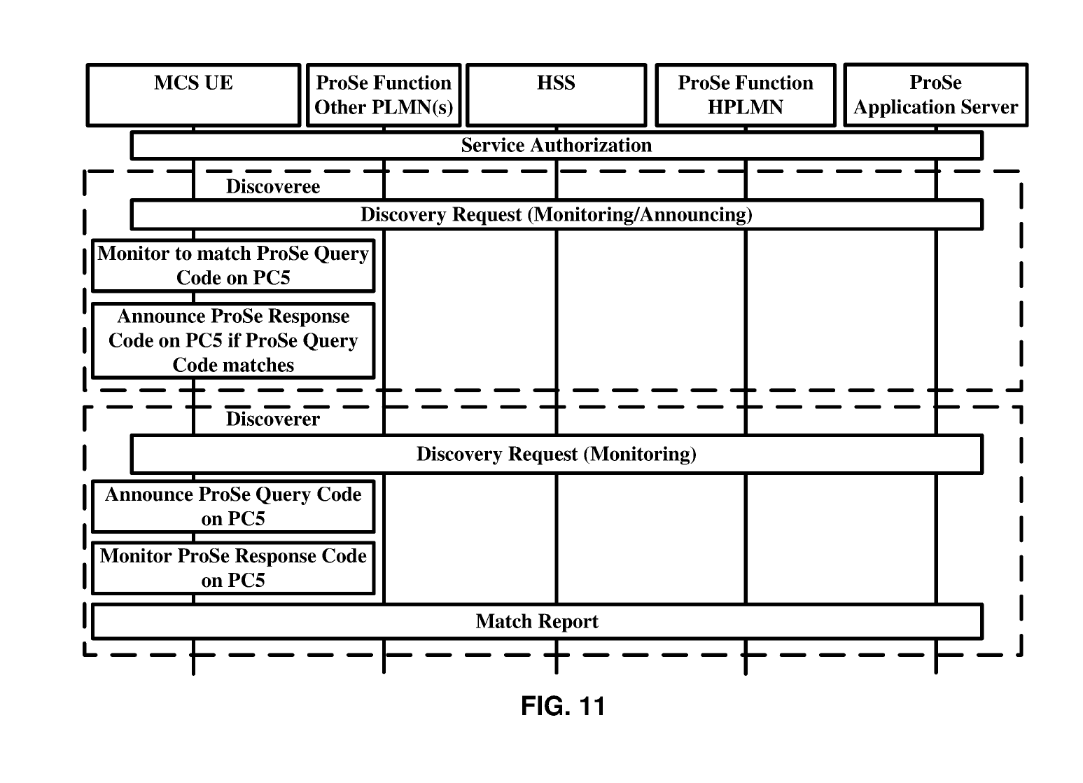

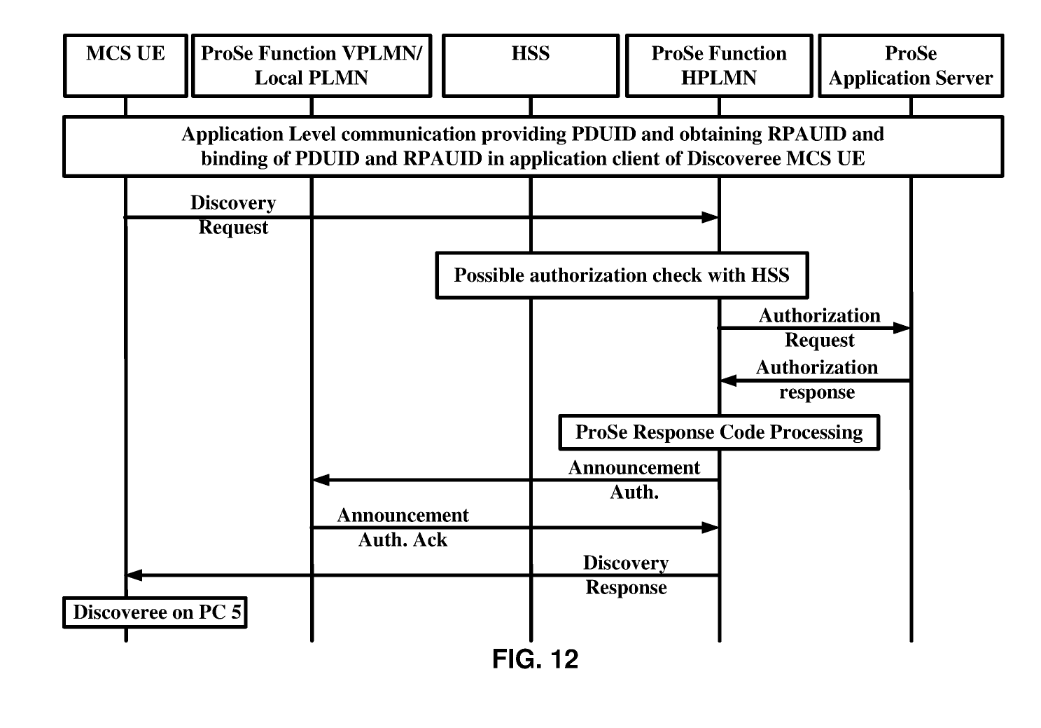

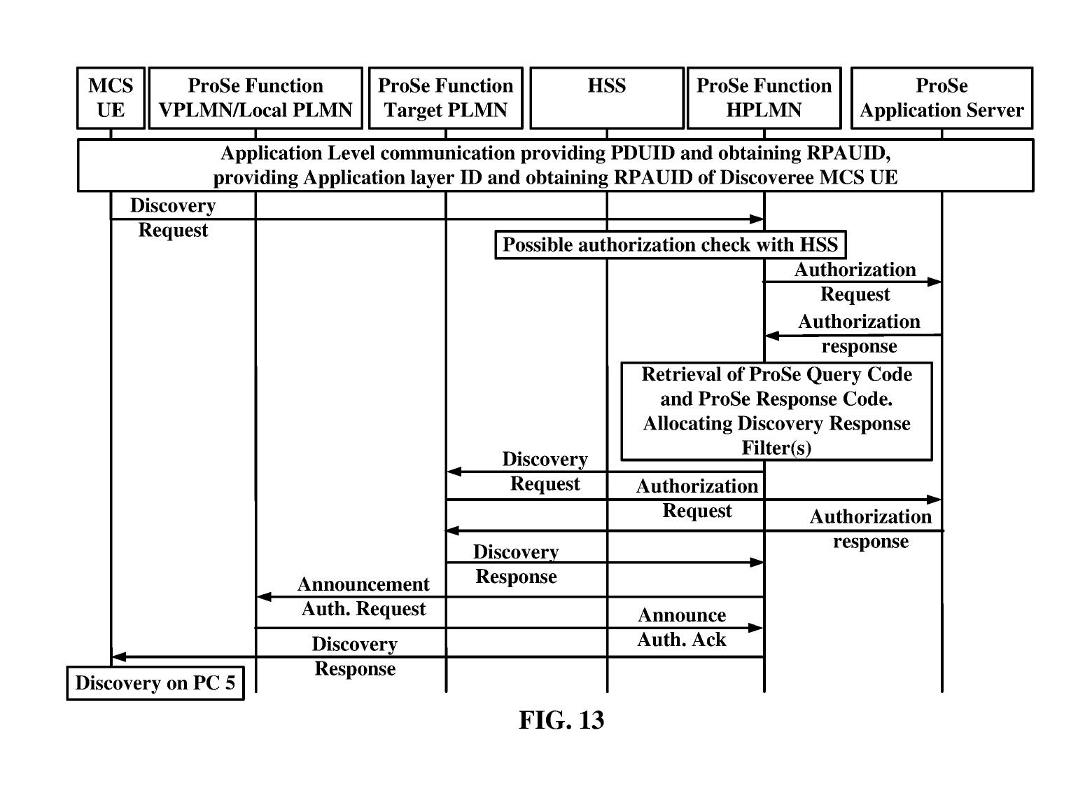

Example discoveree, discoverer, and match-reporting procedures are explained below with respect to FIG. 12, FIG. 13, and FIG. 14. FIG. 12 is a flow diagram showing an example procedure for the discoveree MCS UE. The example procedure for discoveree MCS UE is as follows:

The application client in the MCS UE may retrieve the ProSe discovery UE identity (PDUID) and may provide it to the ProSe application server. The ProSe application server may allocate a restricted ProSe application UE identity (RPAUID) for that PDUID, may store the binding between the PDUID and the RPAUID and may return the RPAUID to the application client in the MCS UE. The application client in the MCS UE may store the binding between the RPAUID and its own PDUID and may use those RPAUID to perform discoveree request procedure.

The discoveree MCS UE may establish connection to HPLMN ProSe function and may construct a discovery request message comprising RPAUID set to what the MCS UE will announce, UE identity set to IMSI, command indicating this is for discoveree UE, discovery type set to “restricted discovery”, discovery model indicating Model B, application ID set to unique identifier for the application that triggered discovery procedure, discovery entry ID showing the discovery identity that it is a new discovery or an existing one, and PLMN ID of the carrier frequency in announcing PLMN ID if the serving PLMN signaled carrier frequency is not operated by HPLMN or VPLMN and if inter-PLMN ProSe discovery transmission is supported. MCS UE may send the discovery request message to HPLMN ProSe function.

HPLMN ProSe function may check for authorization for the MCS application. If there is not any associated MCS UE context, the HPLMN ProSe function may check with HSS and if needed may create a new context for the MCS UE that contains the subscription parameters for this MCS UE. HSS may provide MSISDN of the MCS UE and PLMN ID of where the MCS UE is registered.

The HPLMN ProSe function may locate the ProSe application server based on the application ID in the discovery request message and may send an authorization request containing RPAUID and request type set to “restricted discovery/response” towards the ProSe application server.

The ProSe application server may answer by an authorization response containing PDUID(s) corresponding the RPAUID stored in the ProSe application server and response type set to “restricted discover/response ack”.

The HPLMN ProSe function may verify that at least of one of the PDUID(s) may belong to the discovree MCS UE. The HPLMN ProSe function may assign a ProSe response code and ProSe query code with the associated discovery query filter(s). The ProSe response code corresponds to the RPAUID in the discovery request and the HPLMN ProSe function may assign an associated validity timer for the ProSe response code and ProSe query code with the associated discovery query filter(s). The validity timer identifies the duration of validity of the ProSe response code and ProSe query code with the associated discovery query filter(s). The discoveree MCS UE may use this ProSe response code within this validity duration if PLMN is not changed. The HPLMN ProSe function may store ProSe response code with its associated validity timer and ProSe query code with associated discovery query filter(s) in the context of the MCS user.

If the discovery request is authorized, HPLMN ProSe function may construct announce authorization message containing RPAUID, MCS application ID, ProSe response set to assigned code for this request, UE ID set to IMSI or MSISDN, discovery entry ID to identify the discovery entry, and validity timer indicating how long the ProSe response code will be valid. The HPLMN ProSe function may send the announce authorization message towards the VPLMN ProSe function.

The VPLMN ProSe function may acknowledge the HPLMN ProSe function that it authorizes the MCS UE to perform restricted discovery announcing if the announce authorization message contain a new discovery entry ID. If the discovery entry ID already exists, the VPLMN ProSe function may acknowledge the update as requested i.e. updating the discoveree MCS UE's discovery entry by the new ProSe response code and its associated validity timer.

The HPLMN ProSe function may construct a discovery response message with discovery type set to Model B, ProSe response code, discovery query filter(s) suited for certain ProSe Query code, validity timer associated to ProSe response code and the discovery query filter(s), and discovery entity ID to identify the discovery identity. The MCS discoveree UE may use the discovery query filter(s) (which may be multiple) to determine which ProSe query code triggers that the MCS discoveree UE announces the assigned ProSe response code. The HPLMN ProSe function may send the discovery response message towards MCS discoveree UE.

The MCS discoveree UE may use the discovery query filter(s) which many be multiple to determine which ProSe query code triggers that the MCS discoveree UE announces the assigned ProSe response code. If the validity timer expires, the MCS discoveree ue may send a new discovery request message towards the HPLMN ProSe function.

FIG. 13 is a flow diagram of an example procedure. The procedure for discoverer MCS UE is as follows:

The application client in the MCS UE may retrieve the ProSe discovery UE identity (PDUID) and may provide it to the ProSe application server. The ProSe application server allocates a restricted ProSe application UE identity (RPAUID) for that PDUID, may store the binding between the PDUID and the RPAUID and may return the RPAUID to the application client in the MCS UE. The MCS UE may obtain RPAUIDs of those MCS target users from the ProSe application server passed in an application level container. RPAUID instead of PDUID may be used for public safety feature MCS.

The discoverer MCS UE may establish connection to the MPLMN ProSe function and may construct a discovery request message comprising RPAUID set to what the discoverer MCS UE wants to announce, UE identity set to IMSI, command showing this is for ProSe query procedure, discovery type set to “restricted discover”, discovery model set to Model B, application ID set to unique identifier for the application that triggered discovery procedure, application level container compromising the target RPAUIDs that the MCS UE is to discover, discovery entry ID showing the discovery identity that it is a new discovery or an existing one, and the optional requested discovery timer. The requested discovery timer is set to zero to indicate HPLMN to delete the discovery filter(s) for that discovery entry ID. The MCS UE may send the discovery request message towards HPLMN ProSe Function.

HPLMN ProSe function may check for authorization for the MCS application. If there is not any associated MCS UE context, the HPLMN ProSe function may check with HSS and if needed may create a new context for the MCS UE that contains the subscription parameters for this MCS UE. HSS may provide MSISDN of the MCS UE and PLMN ID of where the MCS UE is registered.

The HPLMN ProSe function may locate the ProSe application server based on the application ID in the discovery request message and may send an authorization request containing RPAUID, request type set to “restricted discovery/query”, and application level container towards the ProSe application server.

The ProSe application server may construct an authorization response comprising target PDUIDs and corresponding target RPAUID that the RPAUID in the authorization request may discover, PDUID of the requesting MCS UE, and response type set to “restricted discovery/query ack”. The ProSe application server may send the authorization response towards the HPLMN ProSe function.

The HPLMN ProSe function may allocate the context for the discoveree UE(s) if the PLMN ID in the target PDUID-target RPAUID corresponds to a valid ProSe response code. The HPLMN ProSe function may allocate the discovery response filter(s) which trigger the MCS discoveree UE to transmit the ProSe response code. This procedure has expiration time which is specified by validity timer.

The HPLMN ProSe function may construct a discovery request message comprising RPAUID of discoveree MCS UE, UE identity set to IMSI or MSISDN, target PDUID and corresponding target RPAUID, application ID set to unique identifier for application that triggered the discovery procedure, and discovery entry ID to identify the discovery entry being new or an existing one. The HPLMN ProSe function may send the discovery request towards the target PLMN ProSe Function which belongs to the discoveree MCS UE. If the discovery entry ID is an existing one, the Target PLMN ProSe function may modify the existing discovery procedure with the parameters included in the discovery request message.

The target ProSe Function has an option to construct an authorization request message comprising RPAUID set to that of the discoverer MCS UE, Request Type set to “restricted discovery/query”, and target RPAUID set to that of the discoveree MCS UE. The target ProSe function may send the authorization request message towards the ProSe application server.

The ProSe application server may acknowledge the target ProSe function by constructing an authorization response message comprising PDUID of the discovery MCS UE, response type set to “restricted discovery/query ack”, and target PDUID of the discoveree MCS UE. The ProSe application server may send the authorization response message towards the target PLMN ProSe function.

The target PLMN ProSe function may allocate the context of the discoveree MCS UE based on target PDUEID-target RPAUID and the application ID. The target PLMN ProSe function may respond with a discovery response comprising ProSe query code which will be used by HPLMN ProSe function to build the discovery query filter so that it triggers the discoveree UE to send ProSe Response code, the actual ProSe response code, and validity timer to indicate for how long the ProSe Query code and ProSe response code are valid.

The HPLMN ProSe function may construct an announce authorization message comprising RPAUID of the discovery MCS UE, application ID, ProSe query code and its associated validity timer, UE identity set to IMSI or MSISDN of discovery MCS UE for charging purposes in the visiting domain, and discovery entry ID to identify the discovery entry. The HPLMN ProSe function may send the announce authorization message towards the VPLMN ProSe function.

The VPLMN may acknowledge that it authorizes the discovery MCS UE to perform ProSe direct discovery procedure. If the discovery entry ID in the announce authorization message corresponded an already discovery entry, the VPLMN ProSe function may acknowledge the replacement of the existing ProSe query code and its associated validity timer.

The HPLMN ProSe function may construct the discovery response message comprising discovery model set to Model B, ProSe query code, one or multiple discovery response filters which are generated by the HPLMN ProSe function based on ProSe response code, and validity timer for how long the ProSe query code and discovery response filter(s) are valid. The HPLMN ProSe Function may transmit the Discovery Response message to the Discoverer MCS UE.

The discoverer MCS UE may obtain the information from the discovery response message to discover discoveree MCS UE. If the validity timer is expired, the discoverer MCS UE may send a new discovery request message towards the HPLMN ProSe function.

FIG. 14 is a flow diagram showing an example matched reporting procedure. An example procedure for match reporting for discoveree/discoverer is as follows:

If the discoverer MCS UE may have received over the air a ProSe response code is matching the discovery response filter obtained in the discovery response message from the HPLMN ProSe function but the discoveree MCS UE does not have an RPAUID with a valid TTL, the discoverer MCS UE may construct a match report message comprising its own RPAUID, its IMSI or MSISDN as UE Identity, discovery type set to “restricted discovery”, application ID set to unique identifier for the application that triggered the monitoring request, the over the air received ProSe response code, optional metadata requested, and discoveree PLMN ID of the PLMN where the discoveree MCS UE was discovered. The discoveree MCS UE may transmit the match report message towards the HPLMN ProSe Function.

The HPLMN ProSe function may verify if the discoverer MCS UE has performed restricted discovery and may analyze Prose response code. The HPLMN ProSe function may identify the discoveree MCS UE's RPAUID in the context of the discoverer MCS UE.

If metadata requested was included to the originated match report message by the discoverer MCS UE, the HPLMN ProSe function may locate the ProSe application server from the application ID and may construct an authorization request message comprising discoverer MCS UE's RPAUID, discoveree MCS UE's RPAUID, and request type set to “restricted discovery/match”. The HPLMN ProSe function may send the authorization request message towards the ProSe application server. This step is optional if metadata requested was not included into the original match report message.

The ProSe application server may construct an authorization response comprising discoverer MCS UE's PDUID, discoveree MCS UE's PDUID, response type set to “restricted discovery/match ack”, and metadata corresponding to the discoveree MCS UE.

The HPLMN ProSe function may verify that the PDUID belongs to the discoverer MCS UE and the discoveree MCS UE's PDUID are the same as the discoveree MCS UE's PDUID that is stored in the context of the discoverer MCS UE.

The HPLMN ProSe function may construct a match report ack comprising application ID set to unique identifier for the application that triggered the discovery request, discoveree MCS UE's RPAUID, validity timer, and optionally meta data.

The discoverer MCS UE may store the mapping between the ProSe response code, discoveree MCS UE's PRAUID, the application ID unique identifier of the application that triggered the discovery procedure, and the related validity timer.

The HPLMN ProSe Function may construct a match report info message comprising discoverer MCS UE's RPAUID, discoveree MCS UE's RPAUID, discoveree MCS UE's Identity set to IMSI or MSISDN for charging purposes, ProSe response code, and discovery type set to “restricted discovery”. The HPLMN ProSe function may send the match report info message towards the discoveree MCS UE's PLMN ProSe function and the ProSe function of the PLMN where the discoveree MCS UE may be roaming in.

In one example embodiment, the discoveree MCPTT UE may retrieve the PDUID and may provide PDUID to the MCPTT application server. The MCPTT application server may allocate RPAUID for PDUID which have been provided by that MCPTT UE. The discoveree MCPTT UE may use the obtained RPAUID instead of PDUID. The MCPTT application server may store the binding between the PDUID and RPAUID.

In one example embodiment, the HPLMN ProSe function obtains RPAUID from the discoveree MCPTT UE and may provide ProSe response code and ProSe query filter matched for certain ProSe query code for that RPAUID to that MCPTT UE. The ProSe response code and ProSe query filter may expire after a certain amount of time.

In one example embodiment, the HPLMN ProSe function obtains RPAUID from the discoveree MCPTT UE and may provide ProSe response code and ProSe query filters matched for certain ProSe query code for that RPAUID to that MCPTT UE. The ProSe response code and ProSe query filters may expire after a certain amount of time.

In another example embodiment, the discoveree MCPTT UE may use ProSe response code to response over interface PC5 to a received ProSe query code which may be matched to the ProSe query filter. In one example embodiment the discoveree MCPTT UE may use ProSe response code to response over interface PC5 to a received ProSe query code which may be matched to one or more of the ProSe query filters. In one example embodiment the ProSe response code and ProSe query filter which may be matched to a ProSe query code indicate discoveree UE media capability e.g. audio, video.

In an example embodiment, the ProSe response code and ProSe query filter which may be matched to a ProSe query code indicate discoveree UE functional capability e.g. data, dispatching, and administering.

In an example embodiment, the ProSe response code and ProSe query filters when one or more of those ProSe query filters may be matched to a ProSe query code indicate discoveree UE media capability e.g. audio, video.

In one example embodiment, the ProSe response code and ProSe query filters when one or more of those ProSe query filters may be matched to a ProSe query code indicate discoveree UE functional capability e.g. data, full duplex, dispatching, and administering.

In one example embodiment, the discoveree MCPTT UE may retrieve the PDUID and may provide it to the MCPTT application server. The MCPTT application server may allocate RPAUID for PDUID which have been provided by that MCPTT UE. The discoveree MCPTT UE may use the obtained RPAUID instead of PDUID. The MCPTT application server may store the binding between the PDUID and RPAUID.

In one example embodiment, the HPLMN ProSe function may obtain RPAUID from the discoveree MCPTT UE and may provide container A and container B matched for container C for that RPAUID to that MCPTT UE. The ProSe response code and ProSe query filter may expire after a certain amount of time.

In one example embodiment, the discoveree MCPTT UE may use container A to respond over interface PC5 to a received container C which may be matched to container C. In another example embodiment, container A and container Bs when one or more of those container Bs may be matched to container C may indicate discoveree UE media capability (e.g. audio, video). In another example embodiment, container A and container Bs when one or more of those container Bs may be matched to container C may indicate discoveree UE functional capability (e.g. data, full duplex, dispatching, and administering).

In one example embodiment, container A may provide a ProSe response code. In one example embodiment container B may be ProSe query filter. In one example embodiment container C may be a ProSe query code.

In one example embodiment, the discoverer MCPTT UE may retrieve the PDUID and may provide it to the MCPTT application server. The MCPTT application server may allocate RPAUID for PDUID provided by that MCPTT UE. The discoverer MCPTT UE may use the obtained RPAUID instead of PDUID. The MCPTT application server may store the binding between the PDUID and RPAUID.

In one example embodiment, the HPLMN ProSe function may obtain RPAUID from the discoverer MCPTT UE and may provide ProSe query code and the ProSe response filter matched for a certain ProSe response code for that RPAUID to the discoverer MCPTT UE. The ProSe query code and the ProSe response filter may expire after a certain amount of time.

In one example embodiment, the HPLMN ProSe function may obtain RPAUID from the discoverer MCPTT UE and may provide ProSe query code and the ProSe response filters matched for a certain ProSe response code for that RPAUID to the discoverer MCPTT UE. The ProSe query code and the ProSe response filters may expire after a certain amount of time.

In one example embodiment, the discoverer MCPTT UE may use a ProSe query code to get a response over a PC5 interface to find out the response is matched to the ProSe response filter. In another example embodiment, the discoverer MCPTT UE may use a ProSe query code to respond over a PC5 interface to find out it is matched to one or more of the ProSe response filters. In another example embodiment, the ProSe query code and ProSe response filter, which may be matched to a ProSe response code, may indicate discoverer UE media capability (e.g. audio, video). In another example embodiment, the ProSe query code and ProSe response filter, which may be matched to a ProSe response code, may indicate discoverer UE functional capability (e.g. data, dispatching, and administering).

In one example embodiment, the ProSe query code and ProSe response filters, when one or more of those ProSe response filters may be matched to a ProSe response code, may indicate discoverer UE media capability(ies) (e.g. audio, video). In another example embodiment, the ProSe query code and ProSe response filters, when one or more of those ProSe response filters may be matched to a ProSe response code, may indicate discoverer UE functional capability(ies) (e.g. data, dispatching, and administering).

In an example embodiment, the discoverer MCPTT UE may retrieve the PDUID and may provide it to the MCPTT application server. The MCPTT application server may allocate RPAUID for PDUID which have been provided by that MCPTT UE. The discoverer MCPTT UE may use the obtained RPAUID instead of PDUID. The MCPTT application server may store the binding between the PDUID and RPAUID.

In an example embodiment, the HPLMN ProSe function may obtain RPAUID from the discoverer MCPTT UE and may provide container A and one or more container B(s) matched for container C for that RPAUID to that discoverer MCPTT UE. Container A and one or more container B(s) may expire after a certain amount of time.

In an example embodiment, the discoverer MCPTT UE may use container A to get a response over interface PC5 to find out the response is matched to one or more of container B(s). In another example embodiment, container A and one or more container B(s), which may be matched to container C, may indicate discoverer UE media capability(ies) (e.g. audio, video). In another example embodiment, container A and one or more container B(s), which may be matched to container C, may indicate discoverer UE functional capability(ies) (e.g. data, full duplex, dispatching, and administering).

In an example embodiment, container A may be a ProSe query code. In another example embodiment, container B may be a ProSe response filter. In another example embodiment, container C may be ProSe response code.

In an example embodiment, capability information may be exchanged during one of the messages during the discovery process. For example, one of the messages during the discovery (model A or model B) may include one or more parameters indicating the MCPTT UE capability and/or functionality (e.g., audio, video, data, full d-duplex, dispatch, administrator, and/or a combination of these capabilities).

Upon completion of the MCPTT group member discovery, the MCPTT group members may desire to setup an MCPTT group call. In many situations, not all the MCPTT group members may have visibility for each other. Most of the time, the MCPTT group members may not be visible by other members. Even if the MCS group members may be visible to each other at one point, the visibility may change due to, for example, movement of the MCPTT group members.

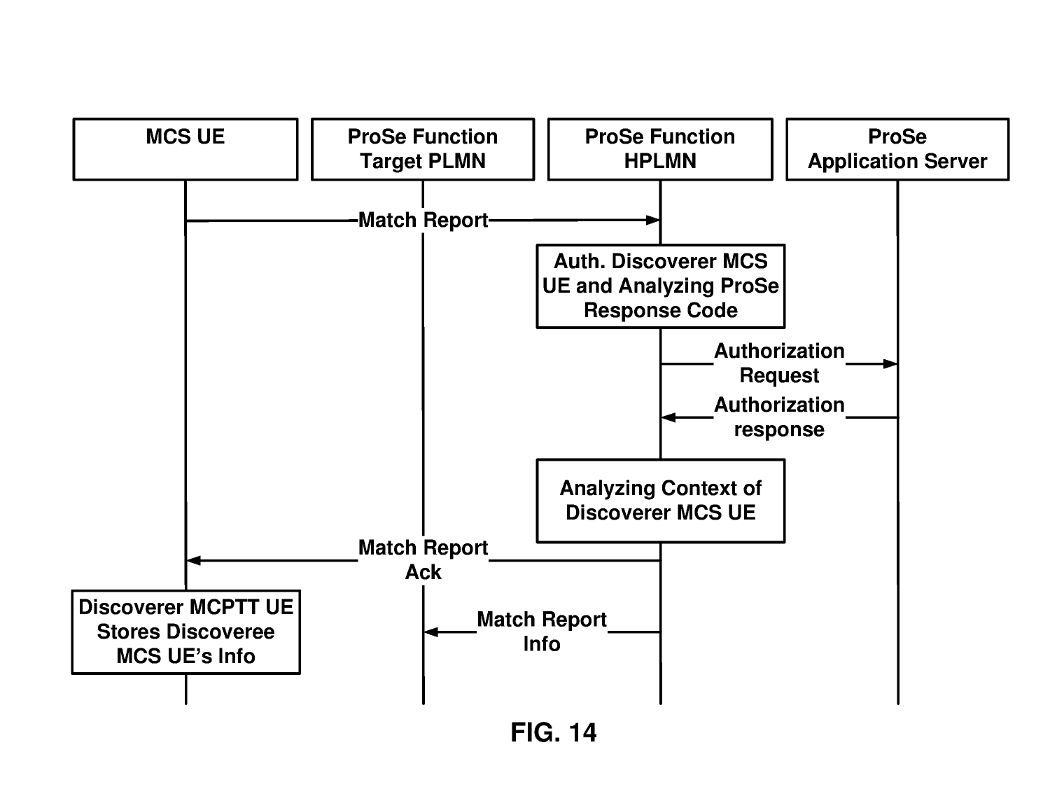

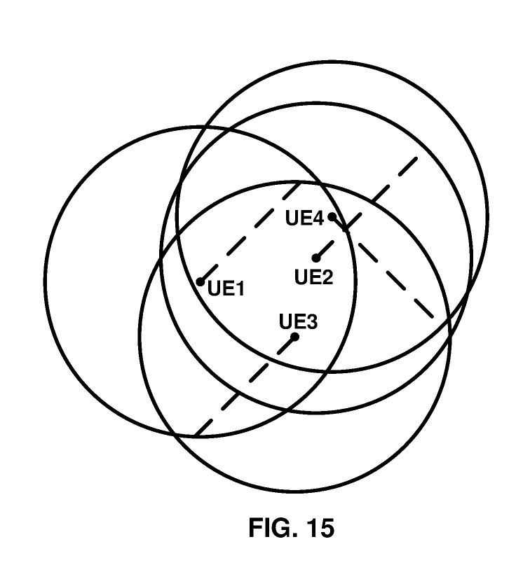

In the example embodiment, shown in FIG. 15, MCPTT UE 1 sees [MCPTT UE 2, MCPTT UE 3, MCPTT UE 4], MCPTT UE 2 sees MCPTT UE 1, MCPTT UE 3, MCPTT UE 4], MCPTT UE 3 sees MCPTT UE 1, MCPTT UE 2, MCPTT UE 4], and MCPTT UE 4 sees [MCPTT UE 1, MCPTT UE 2, MCPTT UE 3]. This may be shown as the example configuration in FIG. 16, in which the number “1” may indicate visibility.

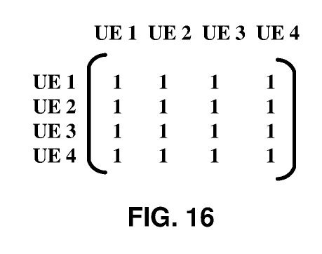

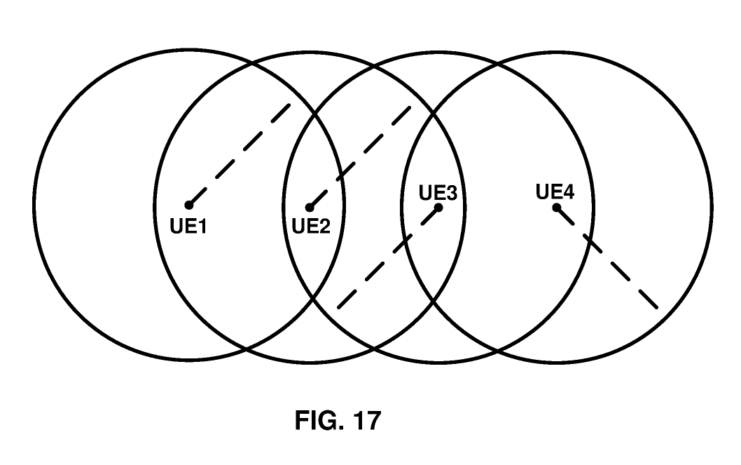

In the example embodiment shown in FIG. 17, due to the possible e.g. movements of the MCPTT group members, the positions of the MCPTT group members may change from FIG. 15. According to the example embodiment shown in FIG. 17, MCPTT UE 1 sees [MCPTT UE 2], MCPTT UE 2 sees [MCPTT UE 3 and MCPTT UE 4], MCPTT UE 3 sees [MCPTT UE 2 and MCPTT UE 4], and MCPTT UE 4 sees [MCPTT UE 3]. This may be presented by the example configuration in FIG. 18, in which “1” may show the visibility while “0” may show lack of visibility. The MCPTT group members who may be in a full communication as shown in the example in FIG. 15, may lose visibility of other MCPTT members e.g. MCPTT UE 1 and MCPTT UE 4 as shown in FIG. 17. This may happen due to the movement of the MCPTT members or other reasons e.g. geographic patterns, location.

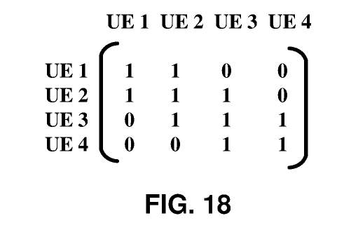

In an example embodiment, the MCPTT group members may be aware of each other's visibility with another word they may know the neighbors' neighbors. FIG. 19 shows an example flow diagram illustrating when MCPTT UE 2 distributes media within the MCPTT group. If MCPTT UE 2 distributes media, MCPTT UE 1 and MCPTT UE 3 may receive that media. If MCPTT UE 1 knows that MCPTT UE 2 has far better visibility than itself (since MCPTT UE 3 may be visible to MCPTT UE 2 while not MCPTT UE 1), then it may realize there is no point to redistribute the media. If MCPTT UE 3 knows that it may have visibility for MCPTT UE 4 while MCPTT UE 2 does not, it may realize that it may need to redistribute the media. MCPTT UE 2 and MCPTT UE 4 may receive the media if the media is redistributed by MCPTT UE 3. MCPTT UE 2 may recognize the media by e.g. tag and may ignore it for being repetitive. MCPTT UE 4 may know that MCPTT UE 3 has better visibility than itself (since MCPTT UE 3 may see MCPTT UE 2 while MCPTT UE 4 may not see MCPTT UE 2), it may realize it may not need to redistribute the media.

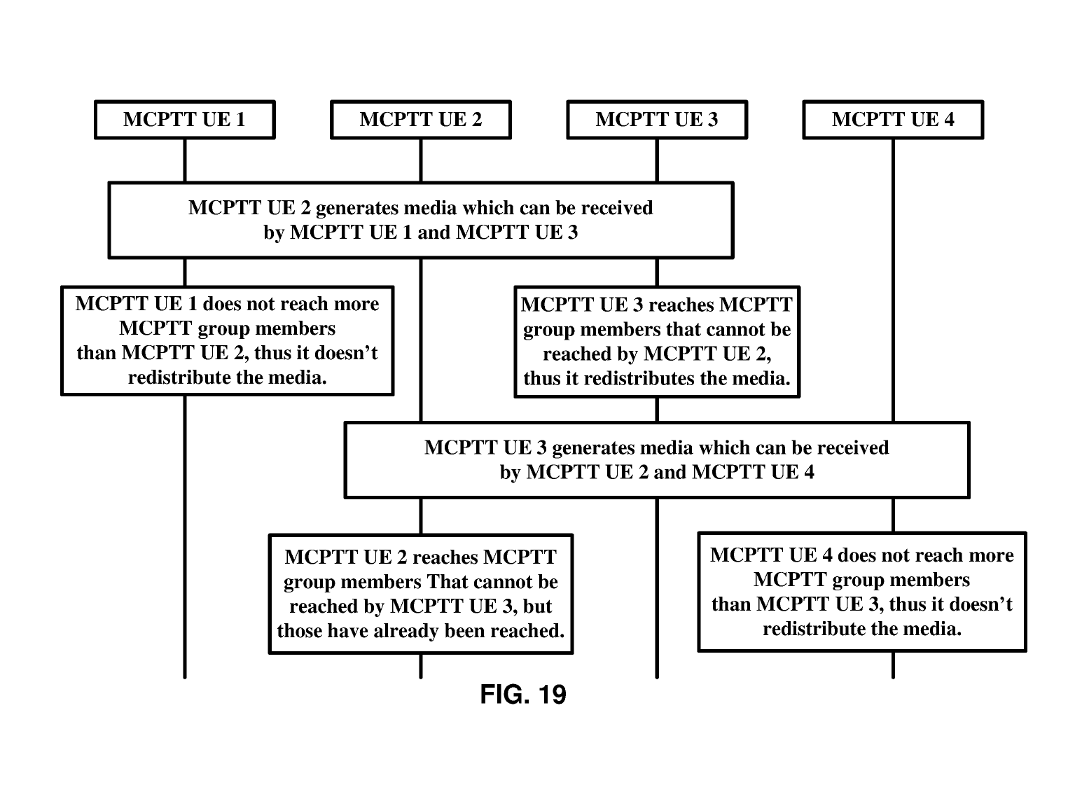

FIG. 20 shows an example configuration illustrating the above scenario where the numbering on the arrows may show an order of the media distribution by MCPTT UE 2 and media redistribution by MCPTT UE 3.

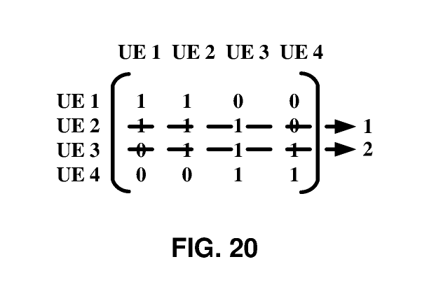

FIG. 21 describes the example embodiment of the procedure of discovery of new MCPTT group members and adding those to the neighboring list. The MCPTT group member may discover a new member at 2110. If a group member is not found, then the MCPTT group member may keep looking until it finds a new MCPTT group member. Once the MCPTT group member finds another MCPTT group member, it may add that discovered member into its neighboring list at 2120, and the MCPTT group member may announce its neighboring list to other MCPTT group members at 2130. Another action in the flow diagram shown in FIG. 21 may be an announcement of the neighboring list at 2140. The announcement may be periodic and may be independent of the discovery of any new MCPTT group members.

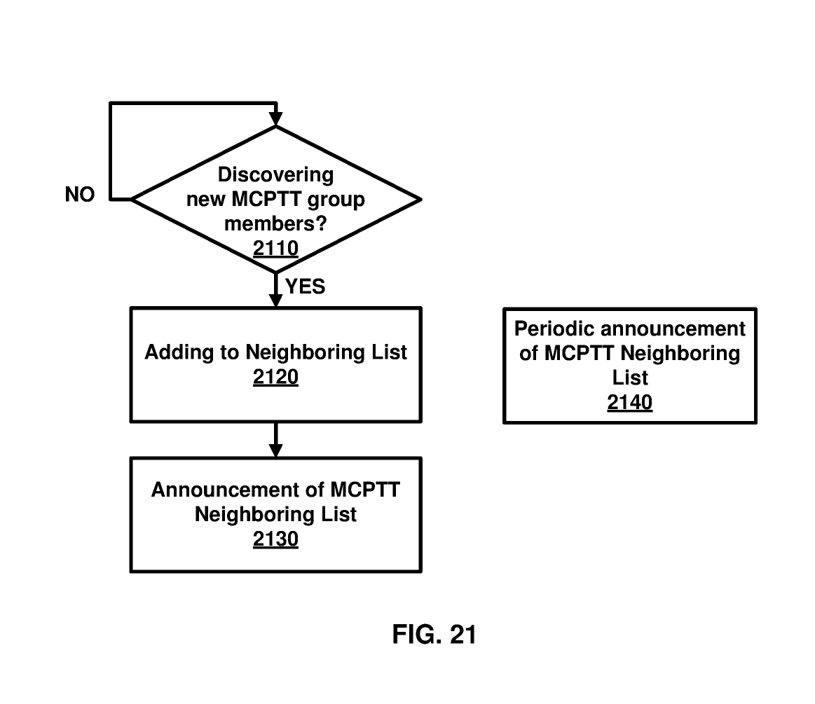

FIG. 22 shows an example embodiment of the procedure of receiving the neighboring list announcement by an MCPTT group. Upon receipt of the announcement of the MCPTT neighboring list 2210, the recipient checks may check at 2220 if the received neighboring list is the same as the local neighboring list. If the answer is “YES”, no action will be taken at 2230. If the answer is “NO”, the local neighboring list may be modified at 2240.

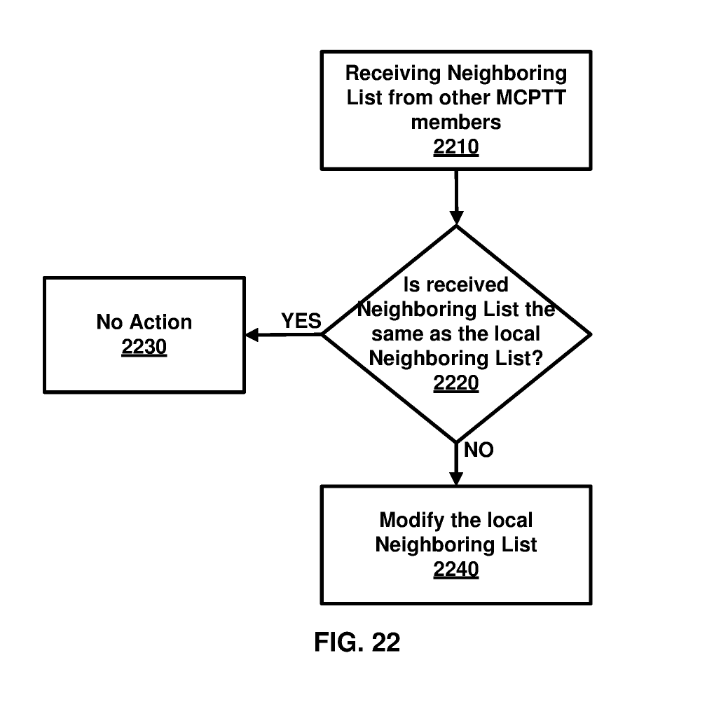

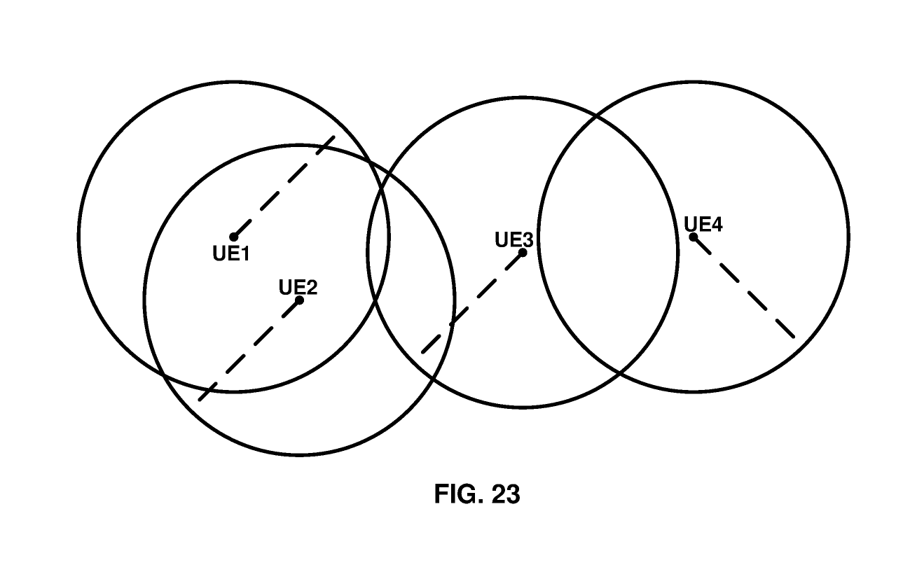

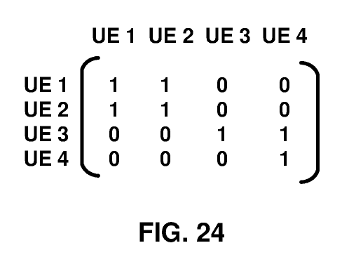

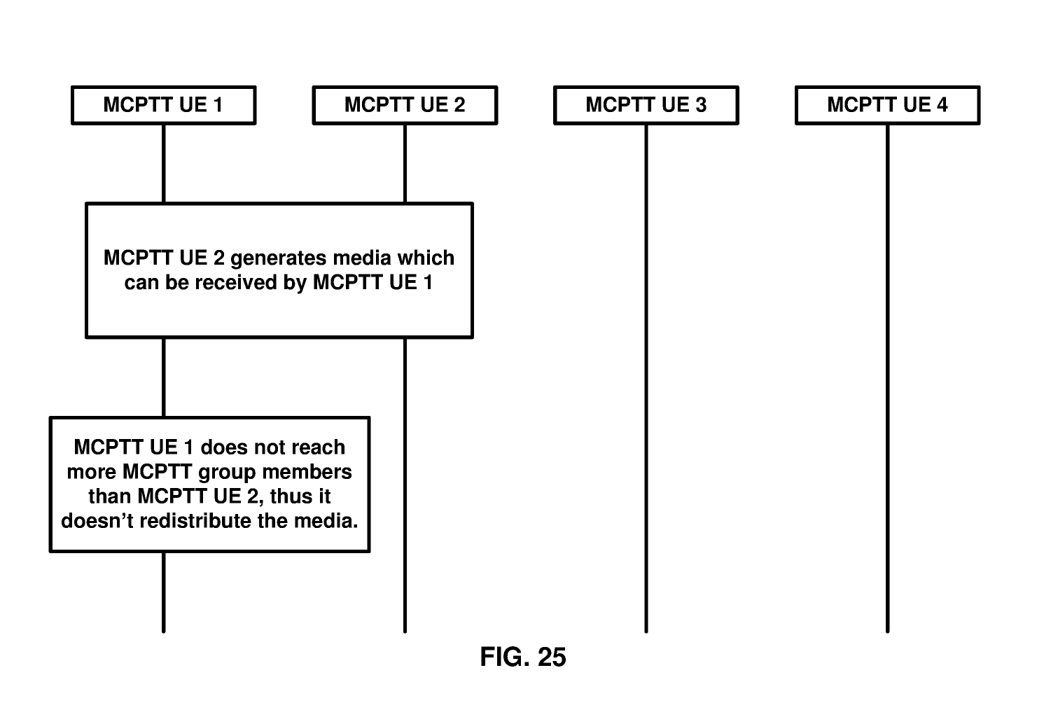

The example embodiment in FIG. 22 may not be applicable when there may exist a disconnect among some of the MCPTT group members as shown in FIG. 23, where MCPTT UE 1 discovers MCPTT UE 2, MCPTT UE 2 discovers MCPTT UE 1, MCPTT UE 3 discovers none, and MCPTT UE 4 discovers none, which may be illustrated a simplified configuration in FIG. 24. If MCPTT UE 2 distributes media, it may only be heard by MCPTT UE 1 due to the existing disconnect between MCPTT UE 3, MCPTT UE 4 from MCPTT UE 1 and MCPTT UE 2. The flow diagram example in FIG. 25 shows MCPTT UE 2 may generate media which may be received by MCPTT UE 2. The local neighboring list of MCPTT UE 2 contains MCPTT UE 1 and therefore MCPTT UE 2 will not re-distribute the media. This example may be illustrated in FIG. 26, where the numbering on the arrows shows there won't be any redistribution. Therefore, the MCPTT group call cannot be established among all the MCPTT group members.

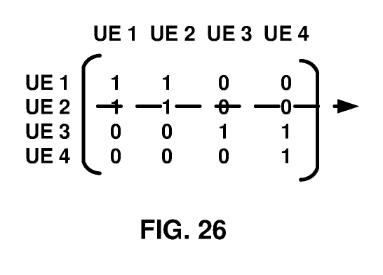

In ProSe discovery Model A, the announced temp ID may comprise a ProSe restricted code or ProSe restricted code Prefix with ProSe restricted code suffix(es) if the application-controlled extension is used. In Model B, the announced temp ID may comprise a ProSe query code or ProSe response code. The length of the announced temp ID may, for example, be 160 bits and may comprise current information about the MCPTT group ID and MCPTT user ID which may be subtracted from ProSe restricted code or ProSe restricted code Prefix with ProSe restricted code suffix(es) if the application-controlled extension is used in Model A and it may be subtracted from ProSe query code, and ProSe response code in Model B. One method to announce the neighboring list to the MCPTT group neighbors may be to process the announced temp ID of the ProSe discovery message with a neighboring list and the required parameters for the ProSe discovery message and distributing the result over PC5 interface as illustrated in FIG. 27. Example FIG. 27 shows that the ProSe discovery message and the neighboring list may be processed into a ProSe discovery message comprising the neighboring list information. If the size of neighboring information is larger than the payload of the ProSe discovery message, then neighboring list may be divided into segments (at 2710) which may get individually processed (2720) by the ProSe discovery message. The transmitting MCPTT UE may transmit the ProSe discovery messages over a PC5 interface.

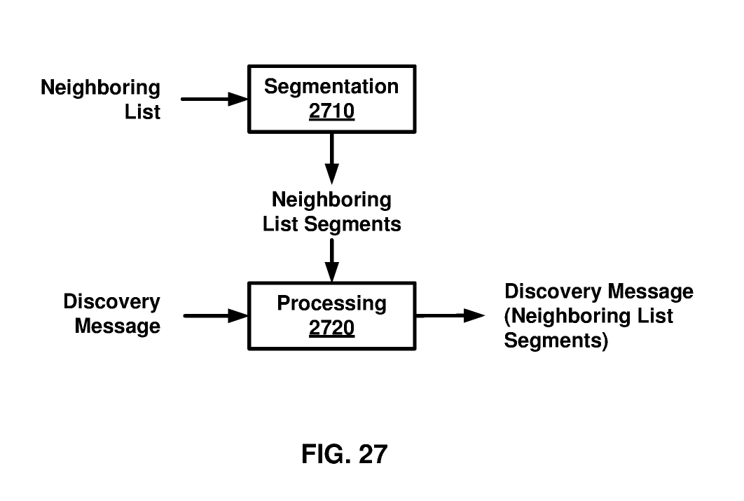

FIG. 28 shows an example embodiment on the recipient side. The recipient MCPTT UEs may receive the ProSe discovery message with the neighboring list information which may be in segments. Having reverse processed (2810) the ProSe discovery message, the recipient MCPTT UE may parse the neighboring list or its segments from the reversed processed ProSe discovery message if the neighboring list is in segments. The recipient MCPTT UE may collect the segments from several received ProSe discover messages to reconstruct the neighboring list (at 2820) belonging to the transmitting MCPTT UE.

In an example embodiment in Model A, the announcing MCPTT UE may retrieve the PDUID and may provide it to the MCPTT application server. The MCPTT application server may allocate RPAUID for PDUID which have been provided by that MCPTT UE. The announcing MCPTT UE may use the obtained RPAUID instead of PDUID. The MCPTT application server may store the binding between the PDUID and RPAUID.

In another example embodiment in Model A, the HPLMN ProSe function may obtain RPAUID from the announcing MCPTT UE and may provide ProSe restricted code for that RPAUID to that MCPTT UE. The ProSe restricted code may expire after a certain amount of time.

In another example embodiment in Model A, the HPLMN ProSe function may obtain RPAUID from the announcing MCPTT UE and may provide a ProSe restricted code prefix with a ProSe restricted code suffix for that RPAUID to the MCPTT UE. The ProSe restricted code prefix with ProSe restricted code suffix may expire after a certain amount of time.

In another example embodiment in Model A, the HPLMN ProSe function may obtain RPAUID from the announcing MCPTT UE and may provide a ProSe restricted code prefix with ProSe restricted code suffixes for that RPAUID to the MCPTT UE. The ProSe restricted code prefix with ProSe restricted code suffixes may expire after a certain amount of time.

In another example embodiment in Model A, the MCPTT UE may use ProSe restricted code to announce its identity over PC5 interface. In another example embodiment in Model A, the MCPTT UE may use ProSe restricted code prefix and ProSe restricted code suffix/ProSe restricted code suffixes to announce its identity over PC5 interface.

In another example embodiment in Model A, the MCPTT UE may use ProSe restricted code to announce its neighboring list to the MCPTT group neighbors over PC5 interface. In one example embodiment in Model A, the MCPTT UE may use ProSe restricted code to announce one or more segments of its neighboring list to the MCPTT group neighbors over PC5 interface. In another example embodiment in Model A, the MCPTT UE may use ProSe restricted code prefix and ProSe restricted code suffix/ProSe restricted code suffixes to announce its neighboring list to the MCPTT group neighbors over PC5 interface.

In another example embodiment in Model A, the MCPTT UE may use ProSe restricted code prefix and ProSe restricted code suffix/ProSe restricted code suffixes to announce one or more segments its neighboring list to the MCPTT group neighbors over PC5 interface.

In another example embodiment in Model A, the announcing MCPTT UE may retrieve the PDUID and may provide it to the MCPTT application server. The MCPTT application server may allocate RPAUID for PDUID which have been provided by that MCPTT UE. The announcing MCPTT UE may use the obtained RPAUID instead of PDUID. The MCPTT application server may store the binding between the PDUID and RPAUID.

In another example embodiment in Model A, the HPLMN ProSe function may obtain RPAUID from the announcing MCPTT UE and may provide container A for that RPAUID to that MCPTT UE. Container A may expire after a certain amount of time. In one another embodiment in Model A, the MCPTT UE may use container A to announce its identity over PC5 interface. In another example embodiment in Model A, the MCPTT UE may use container A to announce its neighboring list to the MCPTT group neighbors over PC5 interface. In another example embodiment in Model A, the MCPTT UE may use container A to announce one or more segment(s) of its neighboring list to the MCPTT group neighbors over PC5 interface. In one example embodiment container A may be ProSe restricted code and/or ProSe restricted code prefix with ProSe restricted code suffix(es).

In another example embodiment in Model A, the monitoring MCPTT UE may retrieve the PDUID and may provide it to the MCPTT application server. The MCPTT application server may allocate RPAUID for PDUID which have been provided by that MCPTT UE. The monitoring MCPTT UE may use the obtained RPAUID instead of PDUID. The MCPTT application server may store the binding between the PDUID and RPAUID. In another example embodiment in Model A, the HPLMN ProSe function may obtain RPAUID from the monitoring MCPTT UE and may provide discovery filter which may match ProSe restricted code for that RPAUID of the announcing MCPTT UE. The HPLMN ProSe function may provide a time indicator for the expiration of the ProSe restricted code for that RPAUID of the announcing MCPTT UE. In another example embodiment in Model A, the HPLMN ProSe function may obtain RPAUID from the monitoring MCPTT UE and may provide a discovery filter which may match ProSe restricted code Prefix with ProSe restricted code suffix for that RPAUID of the announcing MCPTT UE. The HPLMN ProSe function may provide a time indicator for the expiration of the ProSe restricted code Prefix with ProSe restricted code suffix for that RPAUID of the announcing MCPTT UE.

In another example embodiment in Model A, the HPLMN ProSe function may obtain RPAUID from the monitoring MCPTT UE and may provide a discovery filter which may match ProSe restricted code Prefix with ProSe restricted code suffixes for that RPAUID of the announcing MCPTT UE. The HPLMN ProSe function may provide a time indicator for the expiration of the ProSe restricted code Prefix with ProSe restricted code suffixes for that RPAUID of the announcing MCPTT UE.

In another example embodiment in Model A, the discovery filter of that monitoring MCPTT UE which may match ProSe restricted code indicates announcing UE's neighboring list to the MCPTT group neighbors. In another example embodiment in Model A, the discovery filter of that monitoring MCPTT UE, which may match ProSe restricted code prefix with ProSe restricted code suffixes, may indicate announcing UE's neighboring list to the MCPTT group neighbors.

In another example embodiment in Model A, the monitoring MCPTT UE may retrieve the PDUID and may provide it to the MCPTT application server. The MCPTT application server may allocate RPAUID for PDUID which have been provided by that MCPTT UE. The monitoring MCPTT UE may use the obtained RPAUID instead of PDUID. The MCPTT application server may store the binding between the PDUID and RPAUID.

In another example embodiment in Model A, the HPLMN ProSe function may obtain RPAUID from the monitoring MCPTT UE and may provide container A which may match container B for that RPAUID of the announcing MCPTT UE. The HPLMN ProSe function may provide a time indicator for the expiration of the container B for that RPAUID of the announcing MCPTT UE.

In another example embodiment in Model A, container A of that monitoring MCPTT UE, which may match container B, may indicate announcing UE's neighboring list to the MCPTT group neighbors. In another example embodiment, container A may be a discovery filter. In another example embodiment, container B may be a ProSe restricted code and/or ProSe restricted code Prefix with ProSe restricted code suffix(es).

In an example embodiment in Model B, the discoveree MCPTT UE may retrieve the PDUID and may provide it to the MCPTT application server. The MCPTT application server may allocate RPAUID for PDUID which have been provided by that MCPTT UE. The discoveree MCPTT UE may use the obtained RPAUID instead of PDUID. The MCPTT application server may store the binding between the PDUID and RPAUID.

In another example embodiment in Model B, the HPLMN ProSe function may obtain RPAUID from the discoveree MCPTT UE and may provide ProSe response code and ProSe query filter matched for certain ProSe query code for that RPAUID to that MCPTT UE. The ProSe response code and ProSe query filter may expire after a certain amount of time.

In another example embodiment in Model B, the HPLMN ProSe function may obtain RPAUID from the discoveree MCPTT UE and may provide ProSe response code and ProSe query filters matched for certain ProSe query code for that RPAUID to that MCPTT UE. The ProSe response code and ProSe query filters may expire after a certain amount of time.

In another example embodiment in Model B, the discoveree MCPTT UE may use a ProSe response code to respond over interface PC5 to a received ProSe query code which may be matched to the ProSe query filter. In another example embodiment in Model B, the discoveree MCPTT UE may use ProSe response code to response over interface PC5 to a received ProSe query code which may be matched to one or more of the ProSe query filters.

In another example embodiment in Model B the ProSe response code and one or more ProSe query filter(s) which may be matched to a ProSe query code indicate discoveree UE's neighboring list to the MCPTT group neighbors.

In another example embodiment in Model B, the ProSe response code and one or more ProSe query filter(s), which may be matched to a ProSe query code, may indicate one or more segment(s) of discoveree UE's neighboring list to the MCPTT group neighbors. In another example embodiment in Model B, the discoveree MCPTT UE may retrieve the PDUID and may provide it to the MCPTT application server. The MCPTT application server may allocate RPAUID for PDUID which have been provided by that MCPTT UE. The discoveree MCPTT UE may use the obtained RPAUID instead of PDUID. The MCPTT application server may store the binding between the PDUID and RPAUID. In another example embodiment in Model B, the HPLMN ProSe function may obtain RPAUID from the discoveree MCPTT UE and may provide container A and one or more container B(s) matched for certain container C for that RPAUID to that MCPTT UE. The ProSe response code and ProSe query filter may expire after a certain amount of time.

In another example embodiment in Model B, the discoveree MCPTT UE may use container A to respond over interface PC5 to a received container C which may be matched to the one or more container C(s). In another example embodiment in Model B, container A and one or more container B(s), which may be matched to a container C, may indicate discoveree UE's neighboring list to the MCPTT group neighbors. In another example embodiment in Model B, container A and one or more container B(s), which may be matched to container C, may indicate one or more segment(s) of discoveree UE's neighboring list to the MCPTT group neighbors.

In an example embodiment, container A may be a ProSe response code. In another example embodiment, container A may be a ProSe query filter. In another example embodiment, container A may be a ProSe query code.

In another example embodiment in Model B, the discoverer MCPTT UE may retrieve the PDUID and may provide it to the MCPTT application server. The MCPTT application server may allocate RPAUID for PDUID which have been provided by that MCPTT UE. The discoverer MCPTT UE may use the obtained RPAUID instead of PDUID. The MCPTT application server may store the binding between the PDUID and RPAUID.

In another example embodiment in Model B, the HPLMN ProSe function may obtain RPAUID from the discoverer MCPTT UE and may provide a ProSe query code and the ProSe response filter matched for a certain ProSe response code for that RPAUID to the discoverer MCPTT UE. The ProSe query code and the ProSe response filter may expire after a certain amount of time.

In another example embodiment in Model B, the HPLMN ProSe function may obtain RPAUID from the discoverer MCPTT UE and may provide a ProSe query code and the ProSe response filters matched for a certain ProSe response code for that RPAUID to the discoverer MCPTT UE. The ProSe query code and the ProSe response filters may expire after a certain amount of time.

In another example embodiment in Model B, the discoverer MCPTT UE may use a ProSe query code to respond over interface PC5 to find out it is matched to the ProSe response filter. In another example embodiment in Model B, the discoverer MCPTT UE may use a ProSe query code to response over interface PC5 to find out it is matched to one or more of the ProSe response filters. In another example embodiment in Model B, the ProSe query code and one or more ProSe response filter(s), which may be matched to a ProSe response code, may indicate discoverer UE's neighboring list to the MCPTT group neighbors. In another example embodiment in Model B, the ProSe query code and one or more ProSe response filter(s), which may be matched to a ProSe response code, may indicate one or more segment(s) of discoverer UE's neighboring list to the MCPTT group neighbors.

In another example embodiment in Model B, the discoverer MCPTT UE may retrieve the PDUID and may provide it to the MCPTT application server. The MCPTT application server may allocate RPAUID for PDUID which have been provided by that MCPTT UE. The discoverer MCPTT UE may use the obtained RPAUID instead of PDUID. The MCPTT application server may store the binding between the PDUID and RPAUID. In another example embodiment in Model B, the HPLMN ProSe function may obtain RPAUID from the discoverer MCPTT UE and may provide container A and one or more container B(s) matched for a certain container C for that RPAUID to the discoverer MCPTT UE. The container A and the container B may expire after a certain amount of time.

In another example embodiment in Model B, the discoverer MCPTT UE may use container A to response over interface PC5 to find out it is matched to one or more of container B(s). In another example embodiment in Model B, the container A and one or more container B(s) which may be matched to a container C indicate discoverer UE's neighboring list to the MCPTT group neighbors. In another example embodiment in Model B, container A and one or more container B(s), which may be matched to a container C, may indicate one or more segment(s) of discoverer UE's neighboring list to the MCPTT group neighbors. In another example embodiment, container A may be ProSe query code. In another example embodiment, container B may be a ProSe response filter. In another example embodiment, container C may be ProSe response code.

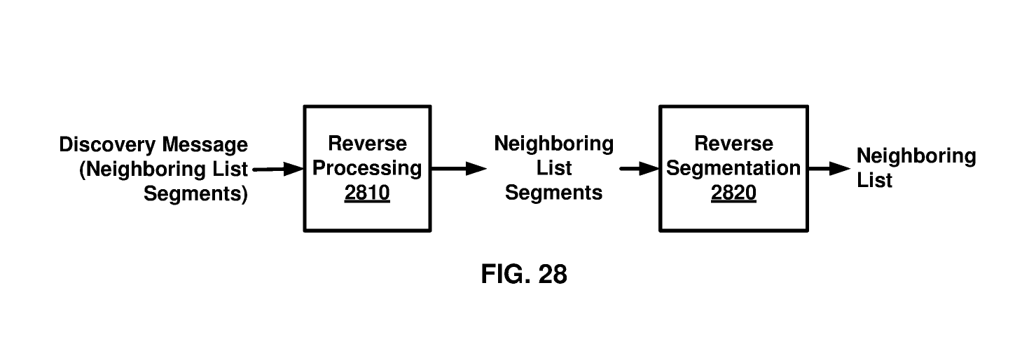

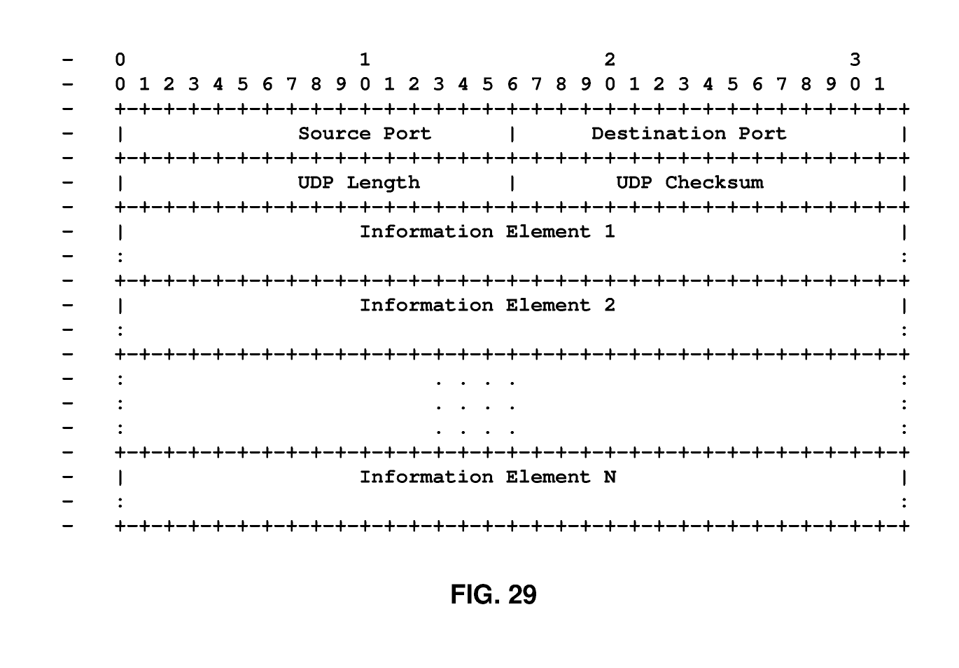

In an example embodiment, the neighboring list of an MCPTT group member may be announced and may be broadcasted by using a payload of user diagram protocol (UDP). An example payload of UDP shown in FIG. 29 with a set of information elements comprising the neighboring list and the related information elements for announcements. The information element may be as illustrated in FIG. 30, where V may be version number and may be set to 1. P may be set to 1 if there is padding at the end of payload otherwise may be set to zero. A may be an address type which may be set to “0” if the off-network MCPTT neighbor list announcer has a specific type of address (e.g. IPV4 address) and may be set to “1” if it has another specific type of address (e.g. IPV6 address). C may be a compression bit which may be set to “1” if the packet is compressed or may be set to “0” if otherwise. E may be an encryption bit which may be set to “1” if the packet is encrypted or may be set to “0” if otherwise (if both compression and encryption are applied to the packet format, the compression may need to be applied first.). Packet Type (PT) may show this is neighboring list (NL) and may be set to a certain value to indicate that this packet may contain the MCPTT neighboring list. Length may comprise the length of the payload of the UDP packet.

In an example embodiment, real-time transport control protocol (RTCP) may be a sister protocol for real-time transport protocol (RTP) (with an example in IETF RFC 3550). RTP may be used for transmission of media between different entities, while RTCP may be used for periodically sending control information to maintain certain quality for the media transmission and synchronization between the media streams. RTCP may have been used as a floor control signaling protocol for application(s) such as, for example, push to talk over cellular (PoC) in OMA or MCPTT in 3GPP standard bodies. The protocol may be light and may be transmitted over user datagram protocol (UDP) which may be connectionless and offers no guarantee to be delivered to the endpoint, but at the same time may not require any tedious connection oriented procedures which may not be suitable for the wireless communications. Therefore, RTCP may, according to an embodiment, be employed for link layer transmission of data burst and thereby announcement of neighboring list.

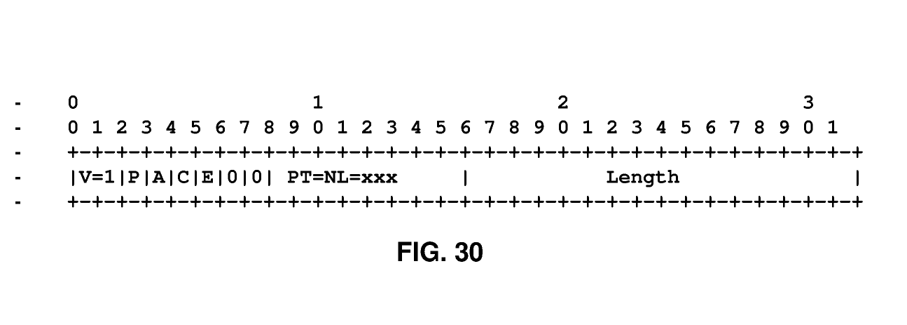

The RTCP packet format may be specified as illustrated in FIG. 31 (as example is shown in IETF RFC 3550). V may be version number and may be set to 2 (an example is shown in IETF RFC 3550). P may be set to 1 if there is padding at the end of payload otherwise may be set to zero. A may be an address type which may be set to “0” if the off-network MCPTT neighbor list announcer has a specific type of address (e.g. IPV4 address) and may be set to “1” if it has another specific type of address (e.g. IPV6 address). C may be a compression bit which may be set to “1” if the packet is compressed or may be set to “0” if otherwise. E may be an encryption bit which may be set to “1” if the packet is encrypted or may be set to “0” if otherwise (if both compression and encryption are applied to the packet format, the compression may need to be applied first). Packet Type (PT) may show this is neighboring list (NL) and may be set to a certain value to indicate that this packet may contain the MCPTT neighboring list. Length may be the length of the RTCP packet. SSRC may be the synchronization source identifier for the originator announcing the MCPTT Neighboring List. NLAP (4 Bytes) may be chosen to define the MCPTT neighboring list announcement protocol packets to be unique with respect to other application packets this MCPTT might receive. The RTCP packet format may also comprise optional authentication data, a list of the MCPTT neighbor ID and possible zero padding to make this field a multiple of 32 bits.

The neighboring list announcement protocol (NLAP) may be broadcasted on a pre-defined channel with a pre-defined port number. Optional authentication data may be added so that the MCPTT users from non-affiliated groups may be able to ignore the neighboring list announcements.

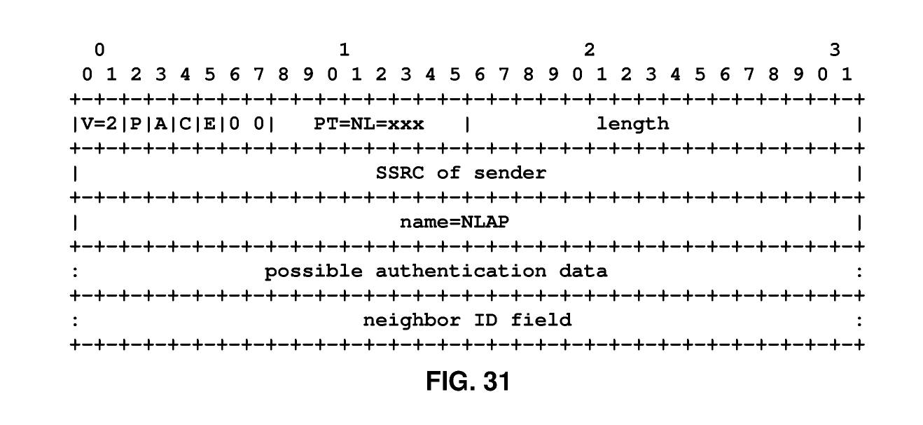

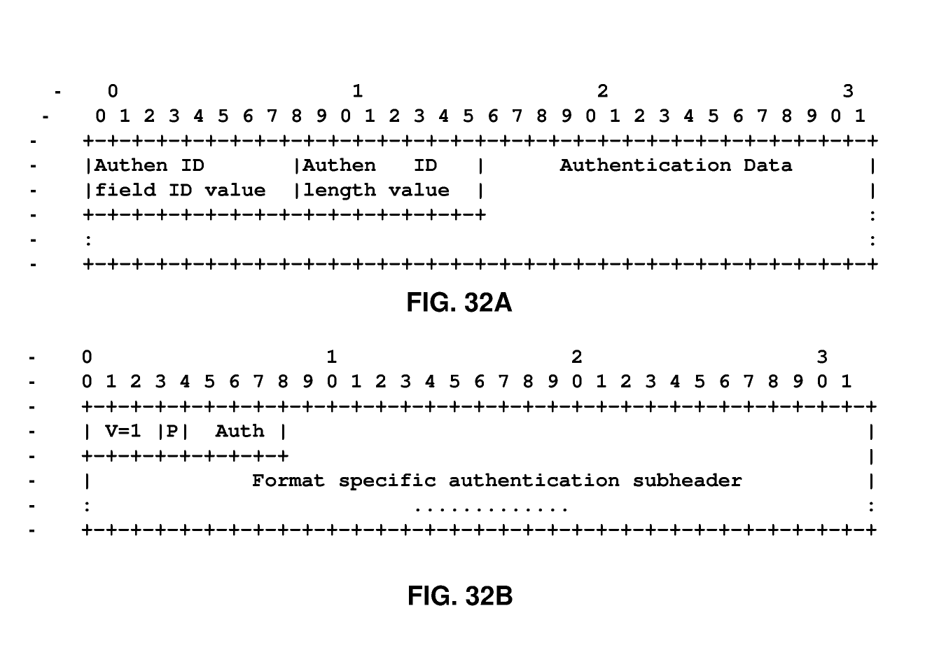

In an example embodiment, an information element in FIG. 29 for authentication data may be as illustrated in example FIG. 32A, where the Authen ID field ID value may be a predefined binary value to indicate this field, Authen ID length ID with its binary value may show the length of this field, and Authentication data may be the authentication data to authenticate the announcer of the neighboring list.

In an example embodiment, an information element in FIG. 29 for authentication data may be as illustrated in FIG. 32B. According to the following figure, an example is shown in IETF RFC 2974). V may be a version number and may be set to “1.” P may be a padding bit and may be set to “1” if authentication data may be padded to be a multiple of 32 bits. Auth may represent an authentication type which may be 4 bits and may be set to “0” if OpenPGP message format (an example in IETF RFC 2440) is employed for authentication. It may be set to “1” if cryptographic message syntax (CMS) (an example in IETF RFC 3369 and IETF RFC 3370), is used for authentication, and format specific authentication subheader may be according to one for OpenPGP authentication (an example in IETF RFC 2440) or may be according to the one for CMS authentication (an example in IETF RFC 3369 and IETF RFC 3370).

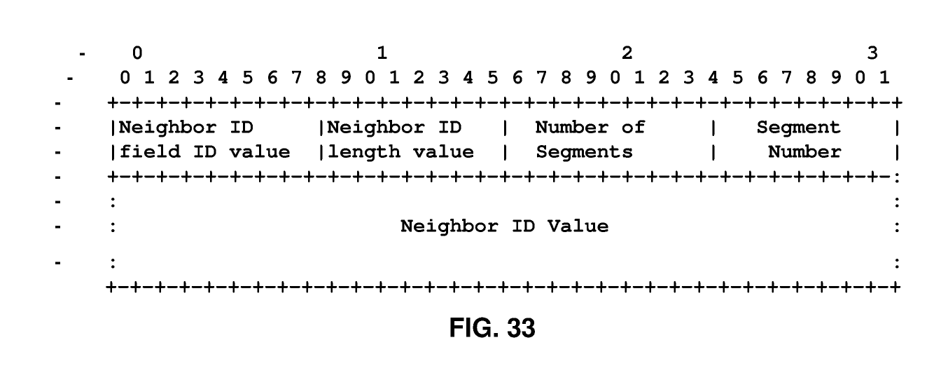

In an example embodiment, an information element in FIG. 29 and/or the neighbor ID field and possible zero padding to make this field a multiple of 32 bits and may be according to the illustration in FIG. 33. According to FIG. 33, a neighbor ID field ID may have a predefined binary value to indicate this field. Neighbor ID length ID with its binary value may show the length of the field. Number of Segments may be the total number of UDP packets in FIG. 25 and/or RTCP packets in FIG. 27 which may be employed to allocate the neighbors in the neighboring list. Segment number may be the current number of total segments employed to announce all the neighbors in neighboring list.

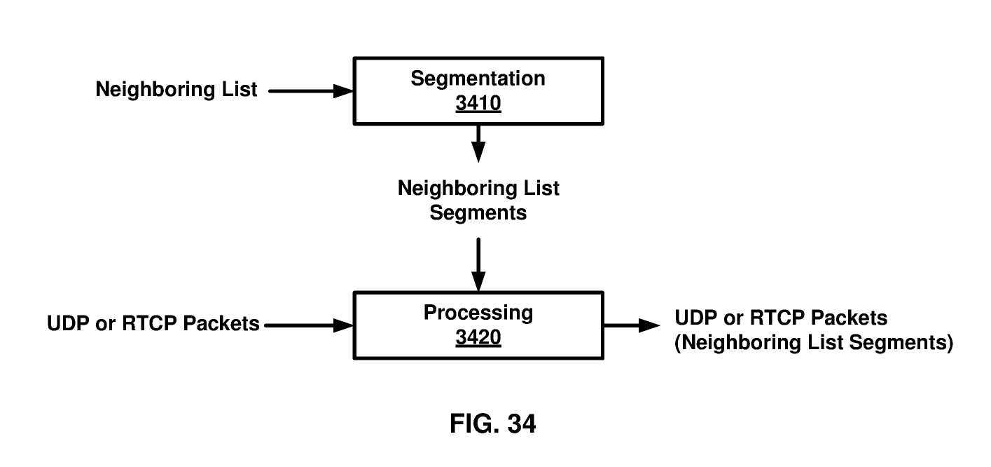

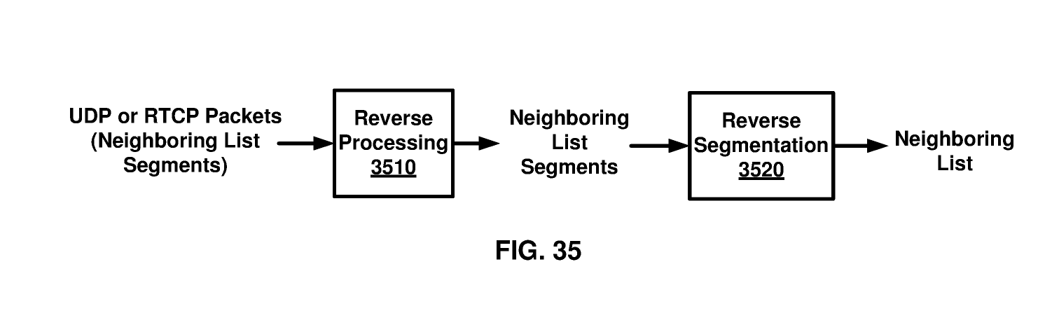

The UDP packets in FIG. 29 and/or RTCP packet in FIG. 31 may be generated periodically by the MCPTT group members. The periodicity may be pre-configured and as illustrated in example FIG. 34. Example FIG. 34 shows the neighboring list processed into the UDP and/or RTCP packets comprising the neighboring list information. If the size of neighboring information is larger than the payload of the UDP and/or RTCP packet, then neighboring list may be divided into segments (3410) which may get individually processed (3420) by the UDP and/or RTCP packets. The transmitting MCPTT UE may transmit the UDP and/or RTCP packets on PC5 interface. FIG. 35 shows an example implementation on the recipient side. The recipient MCPTT UEs may receive the UDP and/or RTCP packets with the neighboring list information which may be in segments. Having reverse processed (at 3510) the UDP and/or RTCP packets, the recipient MCPTT UE may parse the neighboring list or its segments from the reversed processed RTCP packets. If the neighboring list is in several segments, the recipient MCPTT UE may collect all the segments from several received UDP and/or RTCP packets to reconstruct the entire neighboring list belonging to the transmitting MCPTT UE at 3520.

In an example embodiment, an MCPTT member may divide its neighbor list into several segments. In another example embodiment, an MCPTT member may transmit its neighboring list by use of a payload container. In another example embodiment, an MCPTT member may periodically transmit its neighboring list by use of a payload container. In another example embodiment, an MCPTT member may transmit segments of it neighboring list by use of a payload container. In another example embodiment, an MCPTT member may periodically transmit segments of it neighboring list by use of a payload container. In another example embodiment, the payload container may be part of RTCP. In another example embodiment, the RTCP may be transmitted over UDP.

In an example embodiment, the payload container may directly be part of UDP. In another example embodiment, the encryption may be use to encrypt the information about MCPTT neighboring's neighboring list.

In an example embodiment, encryption may be use to encrypt the information about the segments MCPTT neighboring's neighboring list. In another example embodiment, compression may be used to compress the information about the MCPTT members' neighboring list. In another example embodiment, authentication may be used to authenticate the MCPTT member announcing its neighboring list. In another example embodiment, the payload container may identify the payload by an indicator. In another example embodiment, the payload may be identified by an RTCP packet. In another example embodiment, an MCPTT member may receive a payload container comprising an MCPTT user's neighboring list. In another example embodiment, an MCPTT member may receive a payload container comprising a segment of an MCPTT user's neighboring list. In another example embodiment, a recipient MCPTT member may collect all the segments of the neighboring list's segments to build the neighboring list of the announcing MCPTT member.

In an example embodiment, an MCPTT member may receive a payload container as a part of a UDP packet. In another example embodiment, an MCPTT member may receive a payload container as a part of an RTCP packet. In another example embodiment, an MCPTT member may receive an RTCP packet over UDP.

In an example embodiment, a received neighboring list may be encrypted. In another example embodiment, the received segment of the neighboring list may be encrypted. In another example embodiment, the received neighboring list may be compressed. In another example embodiment, the received segment of the neighboring list may be compressed. In another example embodiment, the recipient MCPTT member may need to authenticate the MCPTT member who announces its neighboring list. In another example embodiment, the recipient MCPTT member may authenticate the MCPTT member who announces segments of its neighboring list. In another example embodiment, the recipient MCPTT member may receive a modified neighbor list and may replace the current local one with the received one. In another example embodiment, the recipient MCPTT member may receive the same neighbor list and may replace the current local one with the received one. In another example embodiment, the recipient MCPTT member may receive the modified segment of the neighbor list and may replace the current local one with the received one. In another example embodiment, the recipient MCPTT member may receive the same segment neighbor list and may replace the current local one with the received one. In another example embodiment, the recipient MCPTT member may need to collect all the received segments from the announcing MCPTT member to create the announcing MCPTT user's neighboring list.

An example method for the MCPTT UE to discover each other's capabilities may be at the time of an MCPTT call setup. The MCPTT UEs may be out of coverage and they may not have access to the ProSe function. The necessary parameters for restricted ProSe direct discovery such as ProSe restricted code and discovery filter for Model A Restricted ProSe direct discovery and ProSe query code, ProSe response code, discovery query filter, and discovery response filter for Model B restricted ProSe direct discovery, may have been pre-provisioned in the MCPTT UEs. The MCPTT UEs may not know about each other capabilities in prior to the MCPTT call setup.

The network may not be involved in an off-network MCPTT call. The MCPTT call may be setup as a distributive call. A distributive call setup may be based on a tightly coupled model (an example in IETF RFC 4353). In this model, all the signaling may have a signaling focus while the media may be distributed. A distributive call setup may also be based on a loosely coupled model (an example in IETF RFC 5850). Both signaling and media may be distributed in a loosely coupled model. The loosely coupled model may be recommended for large conferences when there may not be any concept for the floor control. The loosely coupled model may seem to be a good fit for an off-network MCPTT call. In a tightly coupled model, signaling may focus MCPTT UE not to lose coverage of the MCPTT participants. The tightly coupled model call may be destroyed if the signaling focus member loses coverage of the other call members. The loosely couple call model may not get destroyed if a member loses coverage of the other call members. The environment for the off-network MCPTT call members may cause that an MCPTT call member to lose coverage from other call members. The tightly coupled model may not be a good model for an off-network MCPTT call. The loosely coupled model, where there is no signaling focus and/or media focus and everything is distributed, may be employed for the MCPTT call model. The implementation of the mandatory floor control for off-network MCPTT calls may be resolved by rotating the floor arbitration and the floor control queue among the MCPTT members. The off-network MCPTT user who establishes an off-network MCPTT call may become automatically the floor arbitrator and may maintain the floor control queue. The floor arbitrator may not have the highest ranked among the MCPTT group members in that MCPTT group. The off-network MCPTT call establisher who is the current talker, may have automatically become the floor arbitrator and manage the floor control. The current talker may pass the floor to another MCPTT call member in that off-network MCPTT call or if current talker (floor arbitrator) of the off-network MCPTT call may be done with the media transmission and passes the floor to the MCPTT call member next in the floor queue, a high priority call by another call member may interrupt the current talker (floor arbitrator) and the floor and the floor queue is passed to that call member who becomes automatically the floor arbitrator, or a high priority MCPTT call member may interrupt the current talker (floor arbitrator) and may take over the floor and the floor queue and may become floor arbitrator.

If employing the loosely coupled model for the off-network MCPTT call model, the off-network MCPTT call may be need to be established by broadcasting the call specifics such as media type and the related port numbers.

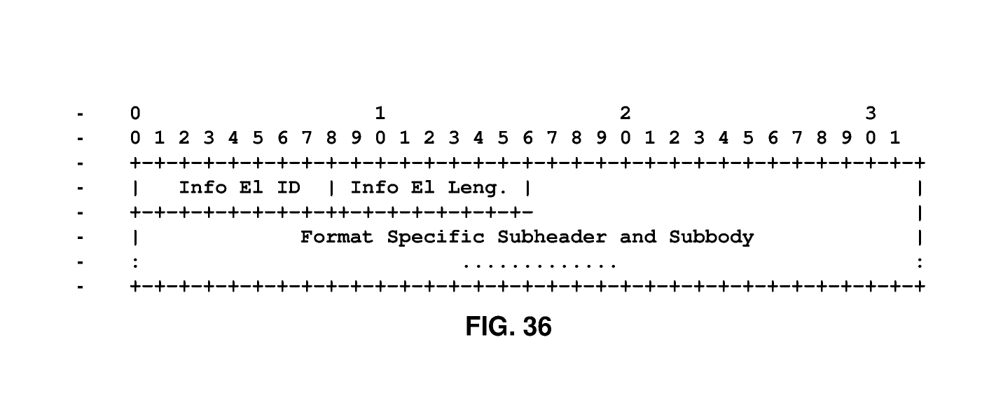

In an example embodiment, an off-network MCPTT call may be established by creating new messages and announcing/broadcasting by using the payload of user diagram protocol (UDP) with a set of information elements comprising the MCPTT call as shown in, for example, FIG. 29, where the information elements of the MCPTT call may be according to, for example, FIG. 36. The information element ID may have a value to identify the information element. The information element length may be the number of 32 bit words for the information subheader and sub-body.

Information elements may describe elements for version identity (which may reflect which version of this protocol is employed), and call identity (which may identify the call if the caller setting up several calls. The call identity and the caller identity may be unique. The MCPTT caller may change the call identity if the MCPTT caller modifies the call information elements. The MCPTT call may keep the call identity the same if the MCPTT caller desires to finish the call immediately. The caller (identity and/or hierarchy), may identify the caller with its identity and its hierarchy. Authentication data may be employed to authenticate the MCPTT caller at the time of establishment, any possible call modification, or any possible call termination. An OpenPGP Message Format (an example in IETF RFC 2440) may be employed for authentication. A Cryptographic Message Syntax (CMS) (an example in IETF RFC 3369 and IETF RFC 3370) may be employed for authentication. Group identity may identify the MCPTT group that the MCPTT caller is affiliated. This parameter may comprise identities from several groups. Organization identity may identify the organization the MCPTT call may belong to. Call interval may identify the periodicity of an MCPTT call announcement. Reject with reason may identify a reason for a rejection. Commencement mode, automatic and/or acknowledgment, may identify that the MCPTT caller may require other MCPTT members automatically joining the MCPTT call or the MCPTT caller may require an acknowledgement in prior to joining the MCPTT call. Caller type such as, dispatcher and/or administrator, may identify an MCPTT caller type who may be a dispatcher or administer. Parameter(s) may be omitted if the caller type is of no importance or may be set to a place holder identifying the MCPTT caller's role. Call type, (such as emergency, imminent peril, normal, and/or full duplex), may identify the nature of an MCPTT call. Call priority may identify the priority of a call. The priorities may be defined with several levels, each of which may represent a level of the MCPTT call priority. Call encryption may identify an employed encryption method to encrypt the UDP packet. Call compression may identify the employed compression method to compress the UDP packet. If both compression and encryption are applied to a UDP packet format, the compression may need to be applied first. Caller location may identify the current location of the MCPTT caller. Call start time may indicate the time of the start of the MCPTT call. Call finish time may indicate when the MCPTT call may be terminated. Call finish time may comprise an absolute time referring when the call ends. Call finish time may comprise a relative time. The format of the call finish time information element may be absolute (e.g. the exact termination time). The format of a call finish time information time may be relative (e.g. how long the call may last). The format of the call may be immediate which may indicate the call may terminate immediately. Device model may reflect the model of the MCPTT UE its capabilities. Communication service may reflect the related service for the announcement of the off-network MCPTT call. Application may reflect the application for the announcement of the MCPTT call. Session description protocol (SDP) may be called the body of the announcement protocol and may comprise an MCPTT call name, MCPTT call information, media type (such as audio, video and/or data), codecs, bandwidths, ports for media, encryption key for media, floor control parameters. SDP may be employed to announce all the specific of the MCPTT call. SDP may describe various parameters for the MCPPT call. An example SDP may be given in IETF RFC 4566 and IETF RFC 4568.

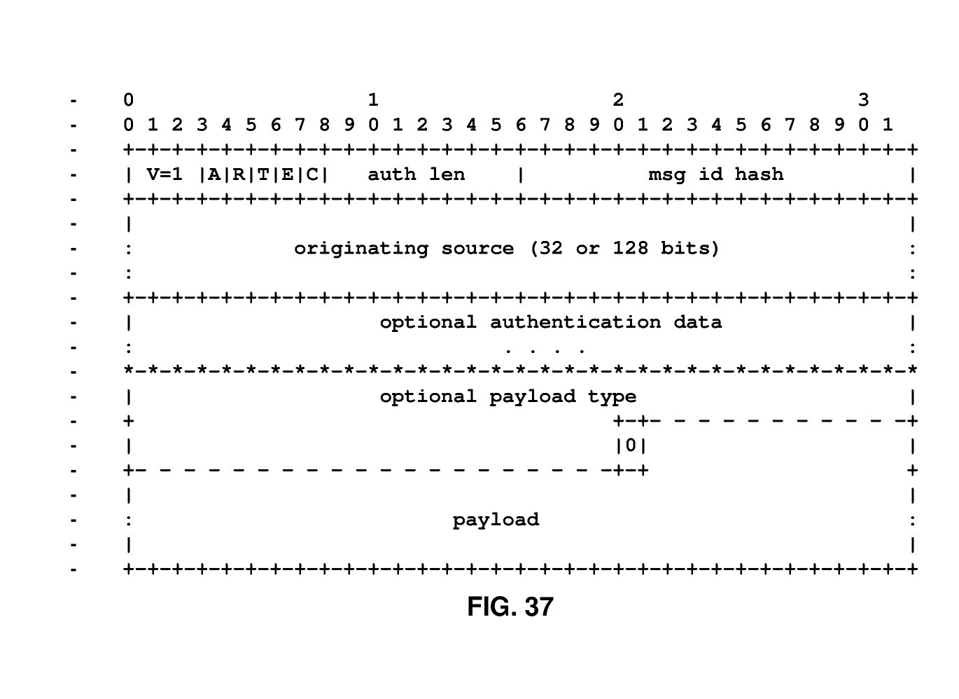

In an example embodiment, an off-network MCPTT call may be established by a session announcement protocol (SAP) (an example in IETF RFC 2974) which is based on announcing and broadcasting session specifics. SAP may be a protocol to announce long-lived and wide-area broadcast sessions. The protocol may be light and may announce the session periodically with periods of tens of minutes. SAP may be transmitted over user datagram protocol (UDP) which may be connectionless and may offer no guarantee to be delivered to the endpoints, but at the same time may not require any tedious connection oriented procedures which may not be suitable for the wireless communications. Due to the broadcast nature of SAP and its periodicity and being transmitted over UDP, SAP may be employed for an off-network MCPTT call setup. FIG. 37 shows the format of an example SAP packet which may have a size less than 1 Kbytes. V may be a version number and may be set to “1.” A may be an address type which may be set to “0” if the off-network MCPTT call establisher has an IPV4 address and may be set to “1” if it has an IPV6 address. R may be a reserved bit which may be set to “0” by the off-network MCPTT call establisher. T may be a message type which may be set to “0” to establish an off-network MCPTT call and may be set to “1” if the intent it to end an already existing off-network MCPTT call. E may be an encryption bit which may be set to “1” if the packet is encrypted or may be set to “0” otherwise. C may be a compression bit which may be set to “1” if the packet is compressed or may be set to “0” otherwise. Authentication length may indicate the number of 32 bit words for the authentication data following the main SAP header. Message identifier hash may be employed in combination with the IP address of the MCPTT call establisher to provide a unique identifier indicating the precis version of this MCPTT call announcement. The value of the message identifier hash may be unique if the MCPTT call specifics are not modified when periodically broadcasted. If the off-network MCPTT call specifics are to be modified, the value of the message identifier hash may be changed. If the off-network MCPTT call is to be terminated, the value of the message identifier hash may be set to the old value when the MCPTT call specifics were broadcasted, originating source may be the IP address of the MCPTT call establisher. It may be 32 bits if using IPV4 and may be 128 bits for IPV6. Authentication data may be optional and have the length indicated by the authentication length header field. The authentication data may be employed to authenticate the MCPTT call member at the time of establishment or any possible modification. Payload type may be a MIME content type specifier which describes the format of the payload. The payload type may be a variable length ASCII text followed by a single zero byte and may be omitted if the payload type is ‘application/sdp.’ Payload may be the body of the SAP packet containing the payload of the message.

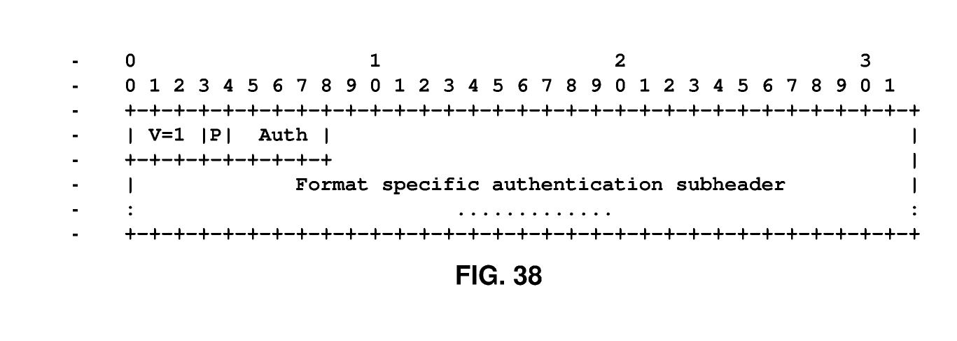

In an embodiment, an example format of the authentication data which is included in the header of the SAP packet is illustrated in example FIG. 38. V may the version number and may be set to “1.” P may be a padding bit and may be set to “1” if authentication data is padded to be a multiple of 32 bits. Auth may be an authentication type which may be 4 bits and may be set to “0” if OpenPGP Message Format (an example in IETF RFC 2440) is employed for authentication. It may be set to “1” if Cryptographic Message Syntax (CMS) (an example in IETF RFC 3369 and IETF RFC 3370) is used for authentication. Some other values may be ignored. A format specific authentication subheader may be defined in IETF RFC 2440 if PGP authentication (an example in IETF RFC 3369 and IETF RFC 3370) if CMS authentication is used.

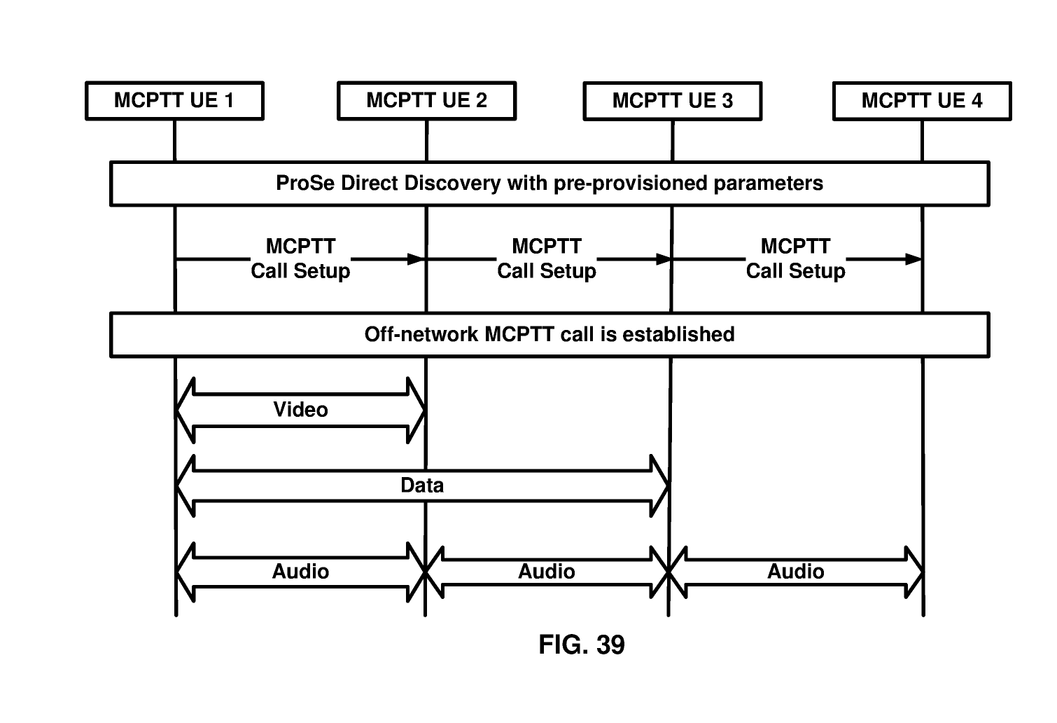

If both compression and encryption are applied to a SAP packet format, the compression may need to be applied first. If a number of off-network MCPTT user have discovered each other by using ProSe direct discovery and they do not have any information about each other's capabilities, there are number of ways they may setup an off-network MCPTT call. In one example embodiment, an off-network MCPTT call may be setup by having a default capability (e.g. audio) for MCPTT UEs comprising new MCPTT UEs or legacy ones. An example MCPTT call setup is shown in example FIG. 39. In this example embodiment, MCPTT UE 1 may have capability of audio, video, and data. MCPTT UE 2 may have a capability of audio and video. MCPTT UE 3 may have a capability of data and audio. MCPTT UE 4 may have a capability of only audio. In this example embodiment once the off-network MCPTT call is established, the media exchange may be accessible by MCPTT call members. The audio media may be employed to communicate with all call members. Other media format(s) (e.g. data and video) may only be accessible to some of the MCPTT call members.

In this example embodiment one MCPTT call may be held for all the MCPTT UEs which may have different capabilities by, for example, having one floor control signaling which may apply to all MCPTT call participants independent of media type. In this example embodiment as shown in FIG. 39, there may be one floor control mechanism for different media communications.

In the example embodiment illustrated in FIG. 39, comprising on floor control signaling shows by, e.g., using pre-provisioned parameters for ProSe direct discovery, the MCPTT UEs may have discovered each other. MCPTT UE1 may have capabilities of audio, video, and data and may set up an off-network MCPTT call by using SDP where the details for audio, video, and data in terms of format, ports, bandwidth, etc. have been specified. An off-network MCPTT call with floor control may be established where the MCPTT UE 1 and MCPTT UE 2 may be in full video communication. MCPTT UE1 and MCPTT UE 3 may be in full data communication and/or MCPTT UE1, MCPTT UE2, MCPTT UE3, and MCPTT UE4 may be in full audio communication.

The example embodiment in FIG. 39 shows that medias (e.g. audio, video, and data) may be communicated one at the time. This may happen when, for example, holding one off-network MCPTT call with one floor control signaling for all MCPTT UEs with different capabilities.

In an example embodiment, the MCPTT UEs may recognize each other capabilities prior to setup an MCPTT call. The off-network MCPTT calls may be separated and may be dependent on the MCPTT UE capabilities. The off-network MCPTT calls may have their own separated floor control signaling. The off-network MCPTT call may be considered as a series of simultaneous off-network MCPTT calls. In another example embodiment, the MCPTT UE may recognize each other capabilities by the information in the header of the session announcement packets. In another example embodiment, the MCPTT UE may recognize each other capabilities by the information in the body of the session announcement packets.

In an example embodiment, it may be simpler and faster to get the MCPTT call initiator session medias and capabilities from the header of the session announcement packet protocol without analyzing the body of the session announcement packet. In another example embodiment, it may be prices and clear to get the MCPTT call initiator session medias and capabilities from the body of the session announcement packet protocol.

In an example embodiment, a combination of the call identity and the caller identity may provide a globally unique identifier showing the exact version of the MCPTT call. In that example embodiment, if an established MCPTT call is modified, the value of call identity may need to be changed. The patterns for call identity may be designed in a way so the MCPTT UEs with the similar capabilities or if they want to use similar capabilities for an off-network MCPTT call may choose the call identity according to those pattern. The patterns of call identity may be used upon receipt of a session announcement for an off-network MCPTT call that the MCPTT UEs may make the decision if their capabilities allow them to join the off-network MCPTT group call. The values for call identity may be pre-provisioned or may be provided by other means such as OMA DM.

In an example embodiment, a combination of the message identifier hash and the originating source may provide a globally unique identifier showing the version of the MCPTT call. In that example embodiment, if an established MCPTT call is modified, the value of message identifier hash may need to be changed. The pattern(s) for message identifier hash may be configured so that the MCPTT UEs with the similar capabilities or if they want to use similar capabilities for an off-network MCPTT call may choose the message identifier hash according to those pattern(s). The pattern(s) of a message identifier hash may be used upon receipt of a session announcement for an off-network MCPTT call that the MCPTT UEs may make the decision if their capabilities allow them to join the off-network MCPTT group call. The values for message identifier hash may be pre-provisioned or may be provided by other means such as OMA DM.

In an example embodiment, the session announcement packet may allow for encryption where the recipient may employ the encryption key to be able to employ the announcement. The announcements for off-network MCPTT group calls with different capabilities may be encrypted in a way that UE(s) with those capabilities have access to the right key for decryption. The information for encryption/decryption may be pre-provisioned or may be provided by other means such as, for example, OMA DM.

In an example embodiment, the session announcement packet may allow the field comprising device model to show the capabilities of the MCPTT UE. In that example embodiment, the recipient of the off-network MCPTT call announcement may employ the field comprising device model to determine if it has the capabilities to join the MCPTT call. The value for the field comprising device model may be pre-provisioned or may be provided by other means such as OMA DM.

In an example embodiment, the session announcement packet may allow the field comprising communication service to show the capabilities of the MCPTT UE. In that example embodiment, the recipient of the off-network MCPTT call announcement may employ the field comprising communication service to determine if it has the capabilities to join the MCPTT call. The value for the field comprising communication service may be pre-provisioned or may be provided by other means such as OMA DM.

In an example embodiment, the session announcement packet may allow the field comprising caller type to show if the caller is dispatcher or administrator. In that example embodiment, the recipient of the off-network MCPTT call announcement may employ the field comprising caller type to determine the caller. The value for the field comprising caller type may be pre-provisioned or may be provided by other means such as, for example, OMA DM.

In an example embodiment, the session announcement packet may allow the field comprising call type to show if, for example, the call is full duplex, for emergency, or for imminent peril. In that example embodiment, the recipient of the off-network MCPTT call announcement may use the field comprising call type to determine the call. The value for the field comprising call type may be pre-provisioned or may be provided by other means such as OMA DM.

In an example embodiment, the session announcement packet may allow the field comprising application to show the capabilities of the MCPTT UE. In that example embodiment, the recipient of the off-network MCPTT call announcement may employ the field comprising application to determine if it has the capabilities to join the MCPTT call. The value for the field comprising application may be pre-provisioned or may be provided by other means such as, for example, OMA DM.

In an example embodiment, the announcement packet protocol may comprise a session description protocol (SDP) where the medias (e.g. audio, video, data and their related properties (e.g. bandwidth, ports)), of the off-network MCPTT group call may be listed. The MCPTT UEs may receive the announcement and may realize if it is capable to join that MCPTT call by analyzing the m-lines in the SDP of the announcement message. Those m-lines list the type of the media which may be employed for that MCPTT call. As an example, the m-line video means the off-network MCPTT call may employed with video media. The receiving MCPTT UE may base on that media line ‘m=’ make the judgement if its capabilities are good enough to join that off-network MCPTT call.

In an example embodiment, the announcement packet protocol may comprise a session description protocol (SDP) that comprises cryptographic parameters of media streams where an encryption key may be required to understand the media which may be used in the off-network MCPTT call. The MCPTT UEs may receive the announcement and may realize if it is capable to join that MCPTT call by analyzing the requested attribute comprising the cryptographic parameters for the media streams that may be employed in the off-network MCPTT call.

In an example embodiment, the off-network MCPTT call announcer may choose to identify the media streams in the off-network MCPTT call by SDP parameters comprising the textual format. The SDP parameters comprising the textual format may be session information parameter ‘i=’ or the session name parameter ‘s=’. The off-network MCPTT UEs may receive these parameters which comprise textual format and make a decision if it may be able to join the off-network MCPTT call. The format of the textual parameters within SDP may be the same as feature tags defined for 3GPP IMS communication service identifier (ICSI) and/or 3GPP IMS application reference identifier (IARI). For example, the textual format of session information parameter and/or session name parameter may be ‘3gpp-service.ims.icsi.mcpttvideo’ and/or ‘3gpp-application.ims.iari.mcpttvideo’ to indicate that the off-network MCPTT call may be based on video. These MCPTT call identifiers may also be set to other flags with binary format but with textual presentation to indicate the video feature of the off-network MCPTT call. Note that the textual format may be required due to format of ‘i=’ and ‘s=’. If an MCPTT UE receives a session announcement message, the receiving UE may realize if its capabilities allow him to join this off-network MCPTT call by parsing the information in ‘i=’ and/or ‘s=’ SDP parameters. The information about feature tags or flags may be pre-provisioned or may be provided by other means such as OMA DM.

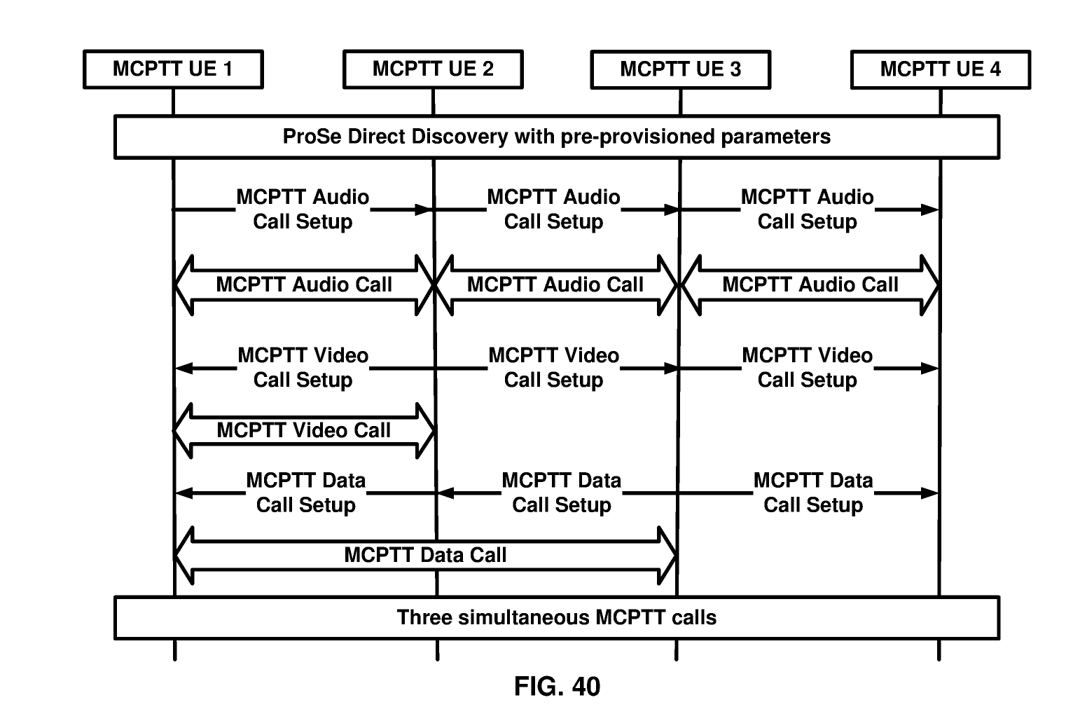

FIG. 40 is a flow diagram illustrating an example embodiment of an off-network MCPTT call setup based on criteria that the MCPTT employs to choose whether to not join due to a lack of capabilities or cannot join due to a lack of an encryption key. The MCPTT UE may recognize a message identifier hash or call identifier to make the decision if it can join the MCPTT call. In the example embodiment shown in FIG. 40, by using pre-provisioned parameters for ProSe direct discovery, the MCPTT UEs may discovered each other. MCPTT UE 1 may have audio, video, and data capabilities and may announce an off-network MCPTT audio call by using either the header parameters or the body (SDP) parameters of the session announcement packet. In an example embodiment, MCPTT UE 1 may choose the header parameters of the announcement package so that MCPTT UE 2, MCPTT UE 3, and MCPTT UE 4 may identify the announced off-network MCPTT call is an MCPTT audio call. In an example embodiment, MCPTT UE 1 chooses the body parameters of the announcement package in a way so MCPTT UE 2, MCPTT UE 3, and MCPTT UE 4 may identify the announced off-network MCPTT call is an MCPTT audio call. MCPTT UE 2, MCPTT UE 3, and MCPTT UE 4 may be audio capable and may join the off-network MCPTT call announced by MCPTT UE 1. MCPTT UE 2 may have audio and video capabilities and may announce an off-network MCPTT video call by employing either the header parameters or the body (SDP) parameters of the session announcement packet. In an example embodiment MCPTT UE 2 may choose the header parameters of the announcement package so that MCPTT UE 1, MCPTT UE 3, and MCPTT UE 4 may identify the announced off-network MCPTT call is an MCPTT video call. In an example embodiment, MCPTT UE 2 may choose the body parameters of the announcement package so that MCPTT UE 1, MCPTT UE 3, and MCPTT UE 4 may identify the announced off-network MCPTT call is an MCPTT video call. MCPTT UE 1 may be capable for video and therefore joins the off-network MCPTT call announced by MCPTT UE 2. MCPTT UE 3 may have audio and data capabilities and may announce an off-network MCPTT data call by using either the header parameters or the body (SDP) parameters of the session announcement packet. In one another embodiment, MCPTT UE 3 may choose the header parameters of the announcement package so that MCPTT UE 1, MCPTT UE 2, and MCPTT UE 4 may identify the announced off-network MCPTT call is an MCPTT data call. In another example embodiment, MCPTT UE 3 may choose the body parameters of the announcement package so that MCPTT UE 1, MCPTT UE 2, and MCPTT UE 4 may identify the announced off-network MCPTT call is an MCPTT data call. MCPTT UE 1 may be capable for data and therefore joins the off-network MCPTT call announced by MCPTT UE 3. Three simultaneous off-network MCPTT calls for audio, video and data may be held, where MCPTT UE 1 may have joined the MCPTT audio, video, and data calls, MCPTT UE 2 may have joined the MCPTT audio and MCPTT video calls, MCPTT UE 3 may have joined MCPTT audio and data calls, and MCPTT UE 4 may have joined MCPTT audio call.

According to various embodiments, a device such as, for example, a wireless device, off-network wireless device, a base station, and/or the like, may comprise one or more processors and memory. The memory may store instructions that, when executed by the one or more processors, cause the device to perform a series of actions. Embodiments of example actions are illustrated in the accompanying figures and specification. Features from various embodiments may be combined to create yet further embodiments.

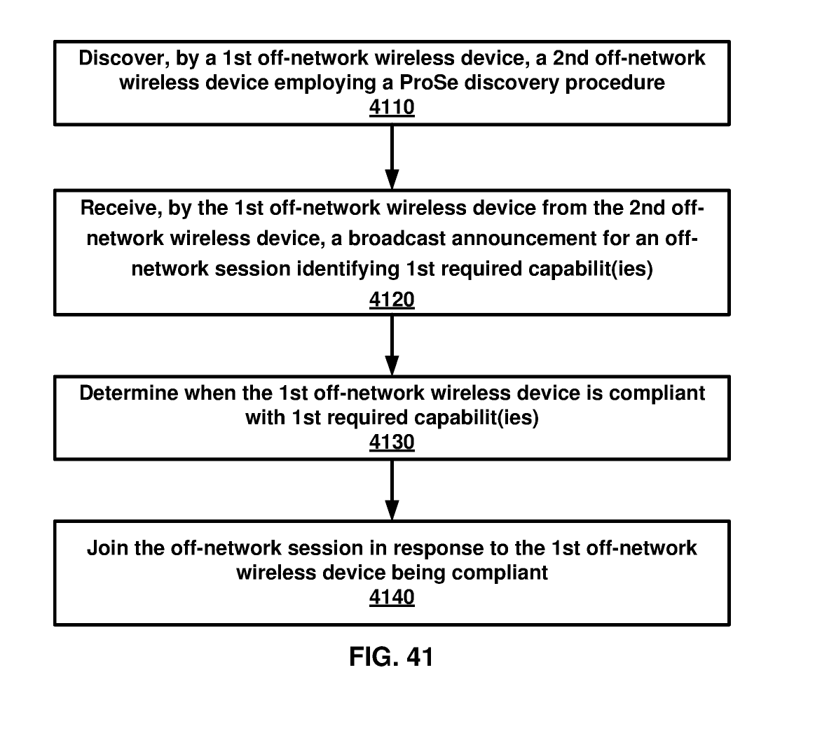

FIG. 41 is an example flow diagram as per an aspect of an embodiment of the present disclosure. At 4110, a first wireless device may discover a second off-network wireless device employing a proximity services (ProSe) discovery procedure. The ProSe discovery procedure may be a mutual ProSe discovery procedure.

At 4120, the first wireless device may receive a broadcast announcement for an off-network session identifying one or more first required capabilities from the second off-network wireless device. According to an embodiment, the one or more first required capabilities may comprise a call identification capability. According to another embodiment, the one or more first required capabilities may comprise an ability to run a predefined application. According to another embodiment, the one or more first required capabilities may comprise an encryption capability. According to another embodiment, the one or more first required capabilities may comprise an ability to be compliant with a specific model of a wireless device. According to another embodiment, the one or more first required capabilities may comprises a communications service capability. According to another embodiment, the one or more first required capabilities may comprise an ability to be compliant with one or more media types. According to another embodiment, the one or more first required capabilities may comprise an ability to be compliant with at least one of: a media compression capability, an encrypted media type, and/or the like.

At 4130, the first wireless device may determine when the first off-network wireless device is compliant with the one or more first required capabilities. At 4140, the first wireless device may join the off-network session in response to the first off-network wireless device being compliant.

According to another embodiment, the first off-network wireless device may further receive from the second off-network wireless devices, a second announcement for a second off-network session. The second broadcast announcement may identify one or more second required capabilities. One or more of the one or more second required capabilities may be similar to the one or more first required capabilities. The first wireless device may further determine whether the first off-network wireless device is compliant with the one or more second required capabilities. The first wireless device may further ignore to join the second off-network session in response to the first off-network wireless device not being compliant.

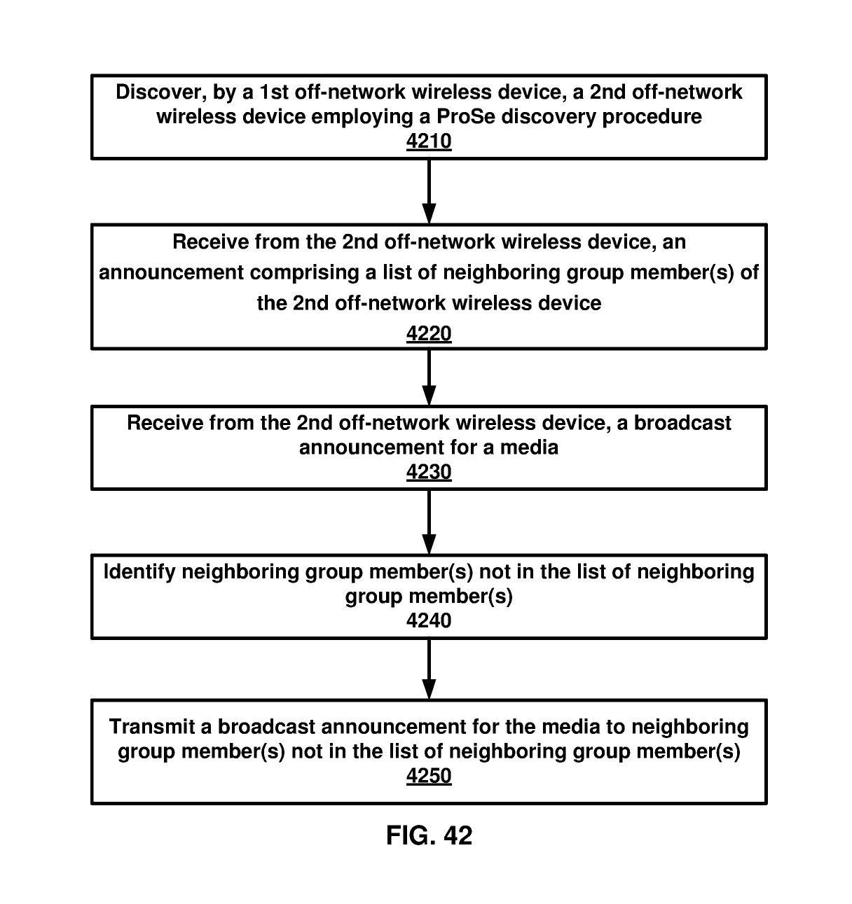

FIG. 42 is an example flow diagram as per an aspect of an embodiment of the present disclosure. At 4210, a first wireless device may discover a second off-network wireless device employing a proximity services (ProSe) discovery procedure. The ProSe discovery procedure may be a mutual ProSe discovery procedure. According to an embodiment, the ProSe discovery procedure may be, for example, Model A or Model B. According to another embodiment, the ProSe discovery procedure may be performed periodically.

At 4220, the first wireless device may receive, the second off-network wireless device, an announcement for a list comprising one or more neighboring group members of the second off-network wireless device. At 4230, the first wireless device may receive, from the second off-network wireless device, a broadcast announcement for a media. According to an embodiment, the media may comprise at least one of: audio, video, data, a combination thereof, and/or the like. At 4240, the first wireless device may identify one or more neighboring group members that are not in the list of one or more neighboring group members. At 4250, the first wireless device may transmit a broadcast announcement for the media to the one or more neighboring group members.

According to an embodiment, the first off-network wireless device, the second off-network wireless device, the list of one or more neighboring group members, and the one or more neighboring group members may be off-network mission wireless devices. According to another embodiment, the first off-network wireless device may be configured to retransmit the media if the one or more neighboring group members are not in the list of one or more neighboring group members. According to another embodiment, the first off-network wireless device may be configured not to retransmit the media, if it has already retransmitted the media. According to another embodiment, the first off-network wireless device may periodically receive the list of one or more neighboring group members from the second off-network wireless device. According to another embodiment, list of one or more neighboring group members is received periodically. According to another embodiment, the list of one or more neighboring group members may be at least one of encrypted; and compressed. According to an embodiment, the second off-network wireless device may transmit the list of one or more neighboring group members in segments, and the first off-network device may reverse segment the list of one or more neighboring group members.

In this specification, “a” and “an” and similar phrases are to be interpreted as “at least one” and “one or more.” In this specification, the term “may” is to be interpreted as “may, for example.” In other words, the term “may” is indicative that the phrase following the term “may” is an example of one of a multitude of suitable possibilities that may, or may not, be employed to one or more of the various embodiments. If A and B are sets and every element of A is also an element of B, A is called a subset of B. In this specification, only non-empty sets and subsets are considered. For example, possible subsets of B={cell1, cell2} are: {cell1}, {cell2}, and {cell1, cell2}.

In this specification, various embodiments are disclosed. Limitations, features, and/or elements from the disclosed example embodiments may be combined to create further embodiments within the scope of the disclosure.

In this specification, parameters (Information elements: IEs) may comprise one or more objects, and each of those objects may comprise one or more other objects. For example, if parameter (IE) N comprises parameter (IE) M, and parameter (IE) M comprises parameter (IE) K, and parameter (IE) K comprises parameter (information element) J, then, for example, N comprises K, and N comprises J. In an example embodiment, when one or more messages comprise a plurality of parameters, it implies that a parameter in the plurality of parameters is in at least one of the one or more messages, but does not have to be in each of the one or more messages.

Many of the elements described in the disclosed embodiments may be implemented as modules. A module is defined here as an isolatable element that performs a defined function and has a defined interface to other elements. The modules described in this disclosure may be implemented in hardware, software in combination with hardware, firmware, wetware (i.e. hardware with a biological element) or a combination thereof, all of which are behaviorally equivalent. For example, modules may be implemented as a software routine written in a computer language configured to be executed by a hardware machine (such as C, C++, Fortran, Java, Basic, Matlab or the like) or a modeling/simulation program such as Simulink, Stateflow, GNU Octave, or LabVIEWMathScript. Additionally, it may be possible to implement modules using physical hardware that incorporates discrete or programmable analog, digital and/or quantum hardware. Examples of programmable hardware comprise: computers, microcontrollers, microprocessors, application-specific integrated circuits (ASICs); field programmable gate arrays (FPGAs); and complex programmable logic devices (CPLDs). Computers, microcontrollers and microprocessors are programmed using languages such as assembly, C, C++ or the like. FPGAs, ASICs and CPLDs are often programmed using hardware description languages (HDL) such as VHSIC hardware description language (VHDL) or Verilog that configure connections between internal hardware modules with lesser functionality on a programmable device. Finally, it needs to be emphasized that the above mentioned technologies are often used in combination to achieve the result of a functional module.

The disclosure of this patent document incorporates material which is subject to copyright protection. The copyright owner has no objection to the facsimile reproduction by anyone of the patent document or the patent disclosure, as it appears in the Patent and Trademark Office patent file or records, for the limited purposes required by law, but otherwise reserves all copyright rights whatsoever.

While various embodiments have been described above, it should be understood that they have been presented by way of example, and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. Thus, the present embodiments should not be limited by any of the above described exemplary embodiments. In particular, it should be noted that, for example purposes, the above explanation has focused on mission critical services such as mission critical push-to-talk services employing media types such as audio services, video services and media services. However, one skilled in the art will recognize that embodiments of the invention may also be implemented in a system comprising other types of services such as, for example, data services, augmented reality services, data fusion services, combinations thereof, and/or the like.

In addition, it should be understood that any figures which highlight the functionality and advantages, are presented for example purposes only. The disclosed architecture is sufficiently flexible and configurable, such that it may be utilized in ways other than that shown. For example, the actions listed in any flowchart may be re-ordered or only optionally used in some embodiments.

Further, the purpose of the Abstract of the Disclosure is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract of the Disclosure is not intended to be limiting as to the scope in any way.

Finally, it is the applicant's intent that only claims that include the express language “means for” or “step for” be interpreted under 35 U.S.C. 112. Claims that do not expressly include the phrase “means for” or “step for” are not to be interpreted under 35 U.S.C. 112.

What is claimed is:

1. A method comprising:
discovering, by a first off-network wireless device, a second off-network wireless device employing a proximity services (ProSe) discovery procedure;
receiving, by the first off-network wireless device from the second off-network wireless device, a broadcast announcement for an off-network session identifying one or more first required capabilities;
determining, by the first off-network wireless device, when the first off-network wireless device is compliant with the one or more first required capabilities; and
joining, by the first off-network wireless devices, the off-network session in response to the first off-network wireless device being compliant.

2. The method according to claim 1, wherein the ProSe discovery procedure is a mutual ProSe discovery procedure.

3. The method of claim 1, further comprising:
receiving, by the first off-network wireless device from the second off-network wireless devices, a second announcement for a second off-network session, the second broadcast announcement identifying one or more second required capabilities;
determining, by the first off-network wireless device, whether the first off-network wireless device is compliant with the one or more second required capabilities; and
ignoring to join, by the first off-network wireless device, the second off-network session in response to the first off-network wireless device not being compliant.

4. A method of claim 1, wherein the one or more first required capabilities comprises a call identification capability.

5. A method of claim 1, wherein the one or more first required capabilities comprises an ability to run a predefined application.

6. A method of claim 1, wherein the one or more first required capabilities comprises an encryption capability.

7. A method of claim 1, wherein the one or more first required capabilities comprises an ability to be compliant with a specific model of a wireless device.

8. A method of claim 1, wherein the one or more first required capabilities comprises a communications service capability.

9. A method of claim 1, wherein the one or more first required capabilities comprises an ability to be compliant with one or more media types.

10. A method of claim 1, wherein the one or more first required capabilities comprises an ability to be compliant with at least one of:
a media compression capability; and
a encrypted media type.

11. An off-network wireless device comprising:
one or more processors; and
memory storing instructions that, when executed, cause the wireless device to:
discover a second off-network wireless device employing a proximity services (ProSe) discovery procedure;
receive from the second off-network wireless device, a first broadcast announcement for an off-network session identifying one or more first required capabilities;
determine compliance to the one or more first required capabilities; and
join the off-network session.

12. The wireless device according to claim 11, wherein the proximity services (ProSe) discovery procedure is a mutual proximity services (ProSe) discovery procedure.

13. The wireless device of claim 1, wherein the instructions are further configured to cause the wireless device to:
receive, from the second off-network wireless device, a second broadcast announcement for a second off-network session, the second broadcast announcement identifying one or more second required capabilities;
determine a lack of compliance to the one or more second required capabilities; and
ignoring to join the second off-network session in response to the first wireless device not being compliant.

14. A wireless device of claim 1, wherein the one or more first required capabilities comprises a capability to identify a call identification.

15. A wireless device of claim 1, wherein the one or more first required capabilities comprise a capability to identify a predefined application.

16. A wireless device of claim 1, wherein the one or more first required capabilities comprise an encryption capability.

17. A wireless device of claim 1, wherein the one or more first required capabilities comprises a capability to be compliant with a specific model of a wireless device.

18. A wireless device of claim 1, wherein the one or more first required capabilities comprises a communications service capability.

19. A wireless device of claim 1, wherein the one or more first required capabilities comprises a capability to be compliant with one or more media types.

20. A wireless device of claim 1, wherein the one or more first required capabilities comprises a capability to be compliant with at least one of
one or more encrypted media types; and
one or more compression capability.
